(19) United States
(12) Patent Application Publication
(10) Pub. No.: US 2002/0109901 A1
(43) Pub. Date: Aug. 15, 2002

(54) Hybrid methods and apparatus for polarization transformation

(76) Inventors: Seong Woo Suh, Florham Park, NJ (US); George R. Gray, Eldersburg, MD (US); Joseph E. Sluz, Ellicott City, MD (US); Edem Ibragimov, Columbia, MD (US); Shih-Cheng Wang, Derwood, MD (US)

Correspondence Address: YAFO NETWORKS, INC., 1340 F CHARWOOD RD., HANOVER, MD, 21076, US

(21) Appl. No.: 09/929,896

(22) Filed: Aug. 15, 2001

Related U.S. Application Data
(60) Provisional application No. 60/226,443, filed on Aug. 18, 2000.
(60) Provisional application No. 60/230,687, filed on Sep. 7, 2000.

(51) Int. Cl. G02F 1/09

(52) U.S. Cl. 359/281

(57) ABSTRACT

Hybrid methods and apparatus for transforming the state of polarization of an electromagnetic wave are provided. The method includes varying both the retardation and the angular rotation of at least one section of a polarization transformer.

### CROSS-REFERENCE TO RELATED APPLICATIONS

This claims priority under 35 U.S.C. 119(e) (1) to U.S. Provisional Patent Application No. 60/226,443, filed Aug. 18, 2000, and No. 60/230,687, filed Sep. 7, 2000, which are hereby incorporated by reference in their entireties.

### FIELD OF THE INVENTION

The present invention relates to methods and apparatus for transforming the state of polarization of light, and particularly to methods and apparatus for transforming an input state of polarization to a desired output state of polarization.

### BACKGROUND OF THE INVENTION

A polarization transformer is an optical device capable of transforming the state of polarization (hereinafter, “SOP”) of an electromagnetic wave. Conventional polarization transformers include either variable retarders or rotatable waveplates. Variable retarders and rotatable waveplates can be distinguished by the way they transform a light beam's SOP. Both devices are usually constructed from externally controllable birefringent materials.

As used herein, the term “variable retarder” refers to a device that can vary the amount of retardation Γ that one polarization component of a light beam experiences relative to another polarization component. In contrast, the term “rotatable waveplate” refers to a device that can vary the pointing direction of its principle axis. The “principal axis” refers to the birefringent axis of, for example, a birefringent medium (crystalline or otherwise).

Before describing this invention, the Poincaré sphere formalism is introduced to provide a framework for describing polarization state dynamics. Then, variable retarders and rotatable waveplates, as well as their operating principles and individual drawbacks, are pointed out. Next, conventional polarization transformers are defined and their drawbacks described, especially in terms of the variable retarders and rotatable waveplates used to construct them. Finally, conventional polarization mode dispersion compensators and their disadvantages are discussed.

Poincaré Sphere Formalism

A Poincaré sphere can be used to describe the polarization, and polarization dynamics, of a propagating electromagnetic wave. Below, the Poincaré sphere is used to illustrate the difference in the way the SOP of a light beam propagates in a variable retarder and a rotatable waveplate.

FIG. 1 shows an illustrative Poincaré sphere. The points on the surface of the sphere represent all possible SOPs, the most general of which is elliptical. Two special SOP cases are circularly and linearly polarized light.

Circularly polarized light can be represented on the surface of the sphere at the two polar extrema (i.e., those points that intersect with axis S₃). In this case, a light beam has an electric vector that can be broken into two perpendicular elements that have equal amplitudes and that differ in phase by a quarter wavelength.

In the case of a linearly polarized light beam, both electric vectors vibrate in a single fixed plane. Linearly polarized light is represented by the points located on the equator of the Poincaré sphere (i.e., those points on the surface of the sphere that intersect with the plane including axes S₁ and S₂). As an example, the two points on the surface of the sphere intersecting with axis S₁ represent vertical and horizontal linear polarization states. Similarly, the two points intersecting with axis S₂ represent a linear polarization state where the plane of polarization is at an angle that is either 45 degrees or −45 degrees with respect to the x-axis.

In a variable retarder, the amount of optical retardation can be varied. FIG. 2 shows how the SOP moves on the surface of a Poincaré sphere when a light beam propagates through a variable retarder. In particular, FIG. 2 shows how the SOP of a light beam at the output of a π retarder, aligned with axis S₁, changes with retardation. In general, the SOP at the output of the retarder moves on the arc of a circle, the center of which represents the retarder's principal axis, and the length of which represents the total change in retardation.

In a rotatable waveplate, the direction of the principal axis can be varied. FIG. 3 shows how the SOP moves on the surface of a Poincaré sphere when a light beam propagates through a rotatable waveplate. In particular, FIG. 3 shows how the SOP at the output of a light beam changes during angular rotation through a π/2 rotatable waveplate. In general, the SOP state moves on a curve having the shape of a “figure-8,” including two lobes. The relative sizes of the lobes depend on the initial SOP of the propagating beam and the fixed retardation of the rotatable waveplate. The distance between the end points of the two lobes, as measured along the surface of the sphere, increases with the fixed retardation of the waveplate.

Variable Retarders

When light having an arbitrary polarization is incident on a birefringent crystal, a portion of the beam travels at v_{f} and another portion travels at vₛ, where v_{f} is the fastest velocity that a light beam can propagate through the crystal, and vₛ is the slowest velocity that a light beam can propagate through the crystal. These separately traveling components cause a certain amount of retardation Γ to accumulate between the two polarizations components. As used herein, the term “retardation” arises from the amount of temporal or spatial delay between the two polarization components.

In general, retardation causes the SOP of a light beam to change. The maximum amount of retardation Γₘₐₓ that can be achieved in a birefringent element, for example, is:

Γmax=(2πcλ(1/vₛ−1/v_{f})L,

where c is the speed of light in free space, λ is the wavelength of light in free space, and L is the length of the element.

There are a number of notable retardation values. When Γ=nπ, where n is an even integer, the two orthogonal polarization components emerging from the birefringent crystal have the same phase relationship as they had when they entered the crystal. Thus, if two polarization components were perfectly in phase when they entered the crystal, they would also be perfectly in phase when they emerged from the crystal.

Another notable retardation value is when Γ=nπ, where n is an odd integer. This value has the effect of a half-wave plate (hereinafter, “HWP”), and can be used to rotate a linear polarization into another linear polarization. Similarly, when Γ=nπ/2, where n is an odd integer, the retardation value has the effect of a quarter-wave waveplate (hereinafter, “QWP”), and can be used to convert a linear polarization state into a circular polarization state, and vice versa.

A variable retarder is normally operated by applying a variable field, such as an externally applied stress field or electric field. Application of such a field effectively changes the optical length within the retarder (e.g., crystal or other material having a variable birefringence) or changes one or both of the polarization component velocities.

General Photonics, of Chino, Calif., makes a polarization transformer that includes a fiber squeezer. As shown in FIG. 4, a stress field can be applied along a particular axis of a single-mode fiber. When the amount of applied stress is zero, all polarization components of a light beam propagating along the fiber travel at the same speed. When a non-zero stress is applied, however, light polarized along the stressed axis travels slower than light polarized along other polarization directions. Because the stress field direction is fixed (by the direction of a piezoelectric actuator, for example), only the magnitude of the retardation can vary—the angle of the retarder is fixed. A polarization transformer, then, can include several variable retarder sections, placed in tandem, each with a different fixed angle.

Corning Incorporated, of Corning, N.Y., also manufactures a variable-retarder-based polarization transformer, but in which case the applied field is electrical rather than stress-induced. As shown in FIG. 5, this type of transformer includes an electro-optic material that varies the speed of propagating light based on the magnitude and direction of an applied electric field.

In this case, the axis of the electric field becomes the fast axis, and, when no field is applied, the material is isotropic and all polarization components travel the same speed. Once again, because the amount of retardation Γ can be varied while maintaining the direction of the applied electric field, the device acts like a variable retarder. As explained more fully below, a polarization transformer can be constructed by concatenating several electro-optical sections, each of which has a fast axis that may be oriented at different fixed orientations.

The retardation of a variable retarder cannot, in general, be changed endlessly. The minimum value is generally small (e.g., zero, with no applied field) and the maximum value is determined by various physical constraints. For example, electro-optic materials can only withstand certain maximum electric fields before they are damaged. Also, because a voltage supply has maximum driving voltage, such a supply can only induce a limited amount of electro-optically induced retardation. Moreover, optical fibers can only be squeezed so much before the fiber is damaged. In any case, these limits are “hard” physical limits, which can only be overcome operationally by resetting or unwinding the device. Resetting and unwinding, however, can be unacceptably slow in high-speed applications.

Rotatable Waveplates

In contrast to a variable retarder, which varies the amount of retardation while keeping its principal axis pointing direction fixed, a rotatable waveplate varies its pointing direction while keeping the amount of retardation fixed.

The principal axis generally refers to a birefringent axis of a birefringent medium. The term “angle” or “waveplate angle” θ refers to a relative pointing direction of a device's principal axis with respect to another arbitrary axis, such as an axis fixed with respect to the laboratory reference frame.

One way to vary the pointing direction of a principal axis is to physically rotate it. Physical rotation of a waveplate, however, is typically relatively slow because it is generally limited to the speed of a mechanical actuator (e.g., step motor) used to induce the rotation.

When the rotatable waveplate is constructed from an electro-optical material (e.g., lithium niobate), another way to vary its pointing direction is by applying an appropriately varying electric field. In this case, the birefringent axis is the major axis of the electro-optically induced birefringence ellipse. Thus, when an electric field is applied across an electro-optic medium, a voltage-induced birefringence occurs.

In lithium niobate, for example, a rotatable waveplate can be in the form of a waveguide or a bulk crystal. In either case, however, the electro-optic effect is generally small and, thus, a large electric field (e.g., 100,000 V/cm) is generally necessary to produce a useful amount of retardation. It will be appreciated, then, that a relatively small lithium niobate waveguide can be preferable to bulk lithium niobate crystals because even small voltages can produce large electric fields over small distances, which in the case of waveguides can be on the order of microns.

A rotatable waveplate can be constructed with a lithium niobate waveguide using three separately addressable electrodes. FIGS. 3 and 4 show how a single device can generate horizontal and vertical electric fields, respectively. In both FIGS., the center electrode is grounded. As shown in FIG. 6, when the voltages applied to outer electrodes 30 and 32 are opposite in sign (e.g., V1=−V2), electric field EH is generated in waveguide 35 that is substantially horizontal. Similarly, when the voltages applied to electrodes 30 and 32 have the same sign (e.g., V1=V2), as shown in FIG. 7, electric field E_{V} is generated in waveguide 35 that is substantially vertical.

More generally, varying the ratio of the vertical electric field to the horizontal electric field can control the direction of the principal axis, thereby providing polarization control. That is, tan(2θ)=E_{V}/E_{H} and retardation Γ is proportional to (E_{V}²+E_{H}²)^{½}, where the waveplate angle is θ. Note that these conditions can be satisfied when E_{H} is proportional to cos(2θ) and E_{V} is proportional to sin(2θ). Importantly, the angle can be varied endlessly in a positive or negative direction, even when the applied fields are bounded, because cosine and sine are also bounded functions. Thus, unlike variable retarders, rotatable waveplates can be operated endlessly.

The difference between variable retarders and rotatable waveplates is further illustrated in FIG. 6A. As explained above, a variable retarder has a fixed angle, but allows its retardation to vary within an upper and lower limit. In contrast, a rotatable waveplate has a fixed retardation, but allows its angle to vary, often endlessly. These variations are illustrated in FIG. 6A as horizontal and vertical lines, respectively. It will be appreciated that because no variable retarder or rotatable waveplate is ideal, movement along the horizontal or vertical line is not perfect. Thus, during operation of a conventional device, in which one control parameter is intentionally varied, the other control parameter may unintentionally vary to a small degree.

Polarization Transformers

As mentioned above, a polarization transformer is an optical device capable of transforming the SOP of an electromagnetic wave. Conventional polarization transformers generally include multiple sections that act as variable retarders or rotatable waveplates. They do not include sections that operate as both variable retarders and rotatable waveplates.

For example, a polarization transformer can include four variable retarders, each having a variable retardation between 0 and 2π, and respective angles of 0 degrees, −45 degrees, +45 degrees, and 0 degrees. Such a transformer can be used to transform an arbitrary input SOP into an arbitrary output SOP. In this case, there are four independent control parameters—the retardation of each retarder. It will be appreciated that the retardation of each section can either be tuned to a desired value or controlled by a feedback algorithm.

A polarization transformer made solely from variable retarders has a drawback that can best be understood using the Poincaré sphere representation. As explained above, when a light beam propagates through the variable retarder, that propagation can be illustrated as a revolution of the tip of the SOP vector on the surface of the sphere. Because the retarder is variable, the amount of revolution is also variable.

If the principal axis of a variable retarder and the SOP vector of a light beam are pointing in the same direction, no SOP transformation occurs. Because the goal of a polarization transformer is to transform the SOP of a light beam from an initial SOP to a final SOP, it will be appreciated that when such a condition occurs, the variable retarder does not move the SOP vector any closer to the final SOP, and is effectively useless. In fact, the presence of a variable retarder (within a polarization transformer) aligned with an incident SOP can slow the transformer down, especially when the retardation of the ineffective element is dithered (see below) or otherwise varied.

Moreover, because a variable retarder has physical operating limits, algorithms used to control variable retarders are generally more complex. This complexity arises because once a retardation value approaches its limit, the algorithm must “reset” or “unwind” the retarder in a manner that doesn't cause tracking errors. Unfortunately, extra algorithmic complexity generally reduces the speed of the transformer.

A polarization transformer can also be constructed with rotatable waveplates. As a rule of thumb, a sufficient number of sections are used to produce an overall retardation of at least one wave (e.g., four quarter-wave plates can produce a retardation of one wave). Such a polarization transformer can also make arbitrary to arbitrary SOP transformations. In the case of a set of four quarter-wave waveplates, there would again be four control parameters: the respective angles of each of the sections. In contrast to the polarization transformer that included four variable retarders, however, the four angles can be endlessly controllable. They can be varied in either positive or negative directions—without being reset or unwound. This allows greater simplicity in the control algorithm and, hence, greater speed.

Still, a polarization transformer constructed from one or more rotatable waveplates has a significant drawback. As explained above, when the light beam propagates through the rotatable waveplate, that propagation can be illustrated as a revolution of the tip of the SOP vector on the surface of the Poincaré sphere about an axis that is related to the angle of the waveplate. In this case, the amount of rotation is fixed but the rotation axis can vary endlessly in the equatorial plane of the sphere.

The goal of a polarization transformer is to transform the SOP of a light beam from an initial, or incident, SOP to a final, or target, SOP. Thus, in order for a rotatable waveplate to contribute to the transformation, the rotatable waveplate must move the tip of the SOP vector closer to the target SOP. It will be appreciated, however, that although a rotatable waveplate causes the tip of the SOP vector to rotate on the surface of the sphere, that rotation may not move the tip any closer to the target, or desirable, SOP. Because the rotatable waveplate does not necessarily move the SOP vector any closer to the final SOP, the rotation is ineffective and the waveplate is useless. In fact, the presence of such an element (within a polarization transformer) can slow the transformer down, especially when the ineffective element is dithered (see below) or otherwise varied.

Polarization Mode Dispersion Compensators

Polarization mode dispersion (hereinafter, “PMD”) is a type of optical distortion that is generally recognized as a problem for high-bit rate optical transmission. PMD is caused by variations in birefringence along the optical path that causes the orthogonal optical signal polarization modes to propagate at different velocities. The primary cause of PMD is the asymmetry of the fiber-optic strand. Fiber asymmetry may be inherent in the fiber from the manufacturing process, or it may be a result of mechanical stress on the deployed fiber. Environmental changes are dynamic and statistical in nature, and are believed to result in PMD changes that can last for variable periods of time and vary with wavelength, with the potential for prolonged degradation of data transmission. One solution to the PMD problem is to adaptively compensate for the PMD.

To understand conventional compensation techniques, it is first necessary to understand better how PMD arises. Generally, PMD is introduced into an optical signal during transmission along an optical fiber because small stresses in the fiber induce eccentricities into the normally circular fibers, which can cause the light to propagate at slightly different velocities along two orthogonal directions. A typical fiber, which could be hundreds of kilometers long, normally undergoes varying degrees of stress along its length. That length can be approximated as a number of concatenated shorter sections in which the two propagating velocities are constant within each section. This is known to result in a certain phase delay between the two polarization modes. The principal optical axes in various sections may be randomly oriented with respect to each other.

PMD compensators can be used in fiber-optic transmission systems, such as wavelength-division multiplexed (hereinafter, “WDM”) systems. FIG. 8, for example, illustrates a basic architecture for WDM transmission system 101. A number of laser transmitters 102, each with distinct center frequencies and with distinct signal information, generate separate optical signals. Using optical multiplexer (hereinafter, “MUX”) 104, the generated optical signals are combined and transmitted along optical transmission line 109. Transmission line 109 can include any number of fiber and optical amplifier stages (shown), each of which can act as PMD impairment sources. After transmission across line 109, the transmitted signal is separated by frequency with optical demultiplexer (hereinafter, “DMUX”) 106. Typically, each signal frequency is then detected at dedicated optical receiver 110.

PMD compensators 108 can be placed between optical DMUX 106 and receiver 110 to mitigate, in part or in full, the PMD impairment from the transmission of the combined signal. As shown in FIG. 8, one PMD compensator can be provided for each receiver. Other types of compensation schemes, in which compensator are placed at locations different than the ones shown in FIG. 8, are also known.

Polarization transformers are well suited for use in optical distortion compensators and, in particular, PMD compensators. During operation, a PMD compensator generally receives a PMD-impaired light beam having an initial SOP and transforms the SOP in such a way as to reduce the amount of PMD impairment. Because the initial and target SOP are generally unknown during compensation, polarization transformer control parameters are normally dithered to determine whether an adjustment of the parameter can be used to reduce PMD impairment, and improve the optical signal's quality.

Retardation Γ and waveplate angle θ are two parameters that can be dithered. Unfortunately, there are instances when varying a parameter does not cause the compensator to compensate (i.e., improve) the signal quality. This can occur when varying the parameter either causes no SOP transformation or, if a transformation does occur, the new SOP does not correspond to an improved signal quality. In other words, dithering a parameter may not cause a discernable change in the PMD of the compensator output signal. In effect, then, the dithering step does not contribute to the PMD compensation process, and can actually hinder it by slowing it down.

Thus, it would be desirable to provide methods and apparatus for rapid polarization control and optical distortion compensation.

Polarization transformers constructed from fiber squeezers or from lithium niobate waveguides have advantages and disadvantages. On the one hand, fiber squeezers exhibit the lowest loss, the lowest polarization dependent loss, and perhaps the lowest cost. On the other hand, fiber squeezers are slow and require mechanical actuators, which can be unreliable, rather than applied electric fields. Polarization transformers made from lithium niobate or other electro-optic materials, however, can be used to construct very fast optical distortion compensators because of the material's intrinsic speed and the simplicity of its control algorithm.

Lithium niobate devices, however, generally suffer from substantial insertion loss (e.g., about 3 dB). This loss may be at least partly due to the optical coupling between the optical fiber and the waveguide and partly to losses that occur within the lithium niobate material itself. In contrast, a fiber squeezer suffers minimal loss due to its all-fiber design.

FIG. 9 shows an illustrative block diagram of generic PMD compensator 120. During operation, PMD compensator 120 receives PMD-impaired optical signal 122. Within compensator 120, signal 122 is first received by polarization transformer 124, which transforms the state of polarization of the optical signal for reception at PMD generator 126. Subsequent PMD generator 126 receives the optical signal from polarization transformer 124, adds PMD to the signal, and transmits the optical signal to optical output 129 of PMD compensator 120. PMD compensator 120 is, in this respect, optically transparent.

It will be appreciated that a difference between PMD transformer 124 and PMD generator 126 is that while transformer 124 is can add an amount of retardation, PMD generator 126 can add much larger amounts, usually substantially more than a full wavelength, and often tens, hundreds, or even thousands of wavelengths. To achieve such large amounts of retardation, generators may include relatively long, highly birefringent elements, such as highly birefringent fiber. By varying the SOP of the light with respect to the birefringent axes of the fiber, a variable amount of PMD (e.g., differential group delay) can be generated.

In order to generate a feedback signal that controls polarization transformer 124 and PMD generator 126, a fraction of the optical signal, after passing through generator 126, is directed to optical distortion analyzer 121. Distortion analyzer 121 can generate an error signal, which can be received by control signal generator 128. The error signal can be used to control any electrical and optical components within compensator 120. It will be appreciated that not all PMD compensators have separate transformers and generators, and that transformer 124 and generator 126 can be integrated.

The combination of polarization transformer 124, PMD generator 126, distortion analyzer 121, and control signal generator 128, forms a closed-loop, dynamic feedback system. Polarization transformer 124 and PMD generator 126 are normally controlled such that optical output 129 suffers minimal PMD impairment.

Thus, it would be desirable to provide fast methods and apparatus for transforming the polarization of light that exhibit low loss.

It would be further desirable to provide methods and apparatus for transforming the polarization of light that are simple and reliable.

It would thus also be desirable to provide methods and apparatus for robust and endless PMD control, especially for improved PMD compensation.

### SUMMARY OF THE INVENTION

It is therefore an object of this invention to provide methods and apparatus for transforming the polarization of light.

It is also an object of this invention to provide methods and apparatus for transforming the polarization of light that are fast, simple, and reliable.

It is a further object of this invention to provide methods and apparatus for robust and endless PMD control.

It is yet another object of this invention to provide methods and apparatus for optical distortion compensation, and especially for PMD compensation.

These and other objects are accomplished in accordance with the principles of the present invention by providing methods and apparatus for hybrid polarization control. A hybrid polarization transformer includes at least one section capable of supplying a variable retardation and a variable angular rotation, and a controller programmed to vary both the retardation and angular rotation. The method, then, uses a hybrid polarization transformer to vary the retardation and the angular rotation.

Further features of the invention, its nature and various advantages will be more apparent from the accompanying drawings and the following detailed description of the preferred embodiments.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative Poincaré sphere;

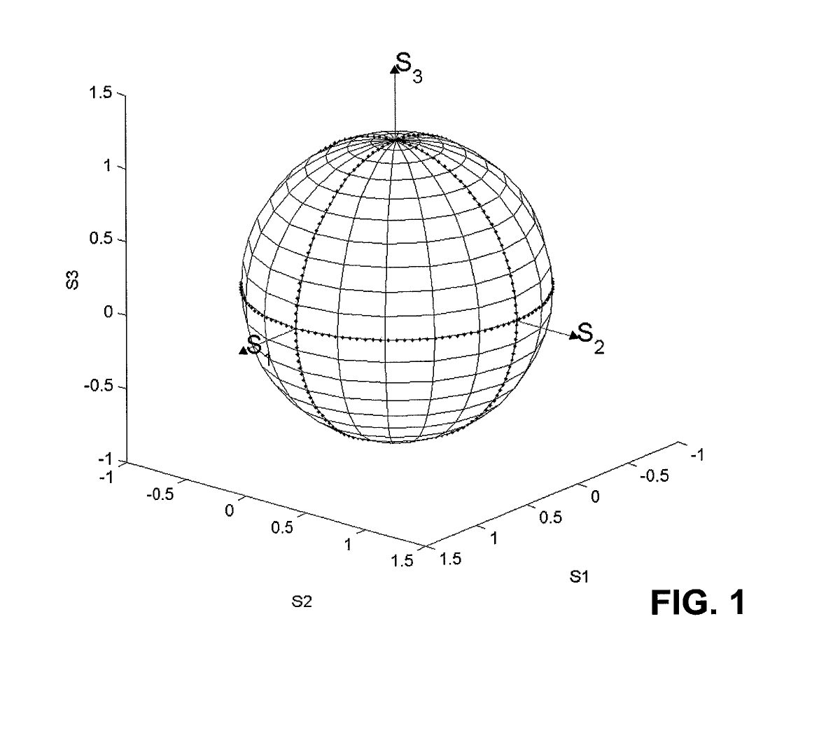

FIG. 2 shows how the SOP moves on the surface of a Poincaré sphere when a light beam propagates through a variable retarder.

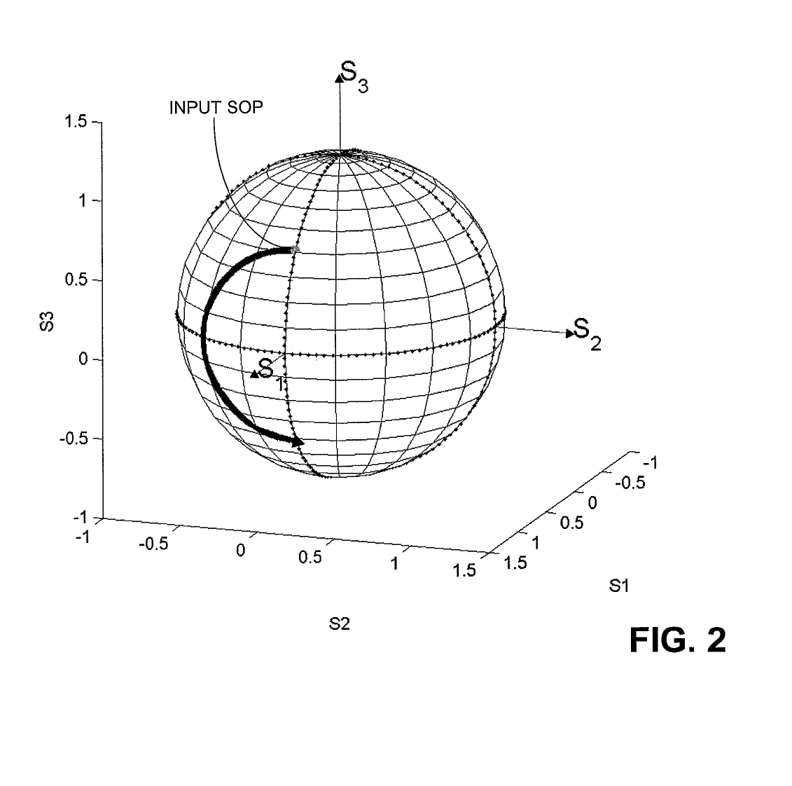

FIG. 3 shows how the SOP moves on the surface of a Poincaré sphere when a light beam propagates through a rotatable waveplate.

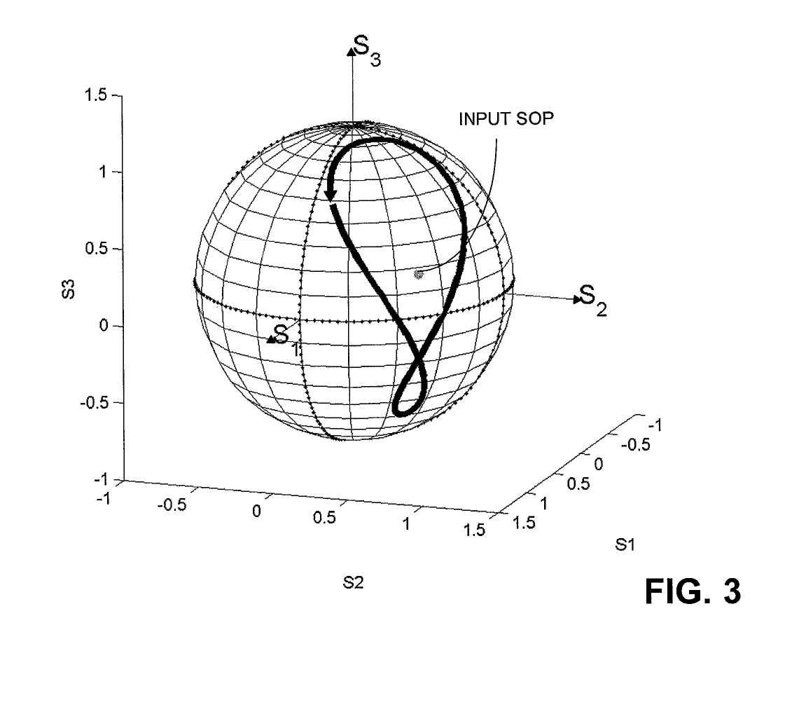

FIG. 4 shows a perspective view of an optical fiber and how a principal axis can be induced by an applied stress field;

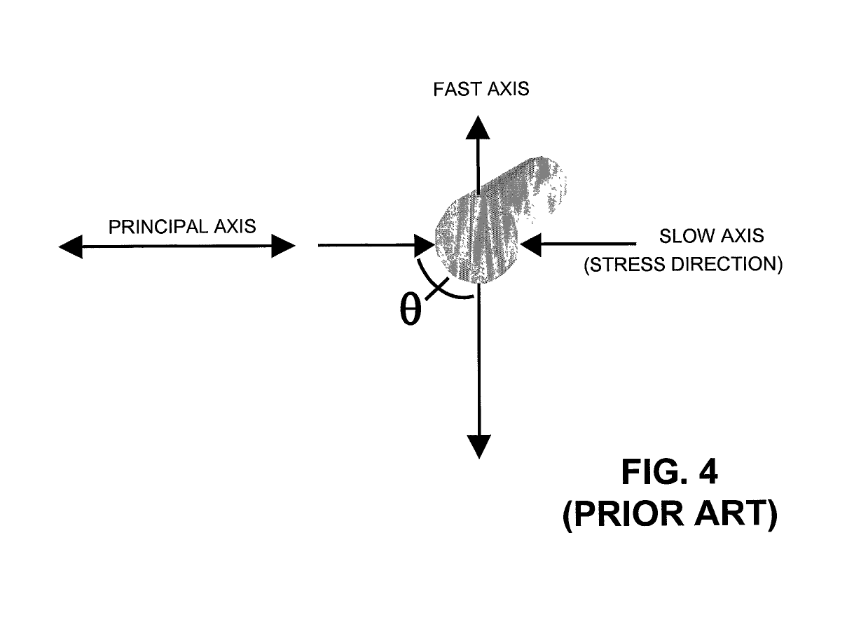

FIG. 5 shows a perspective view of an electro-optic crystal and how a principal axis can be induced by an applied electric field;

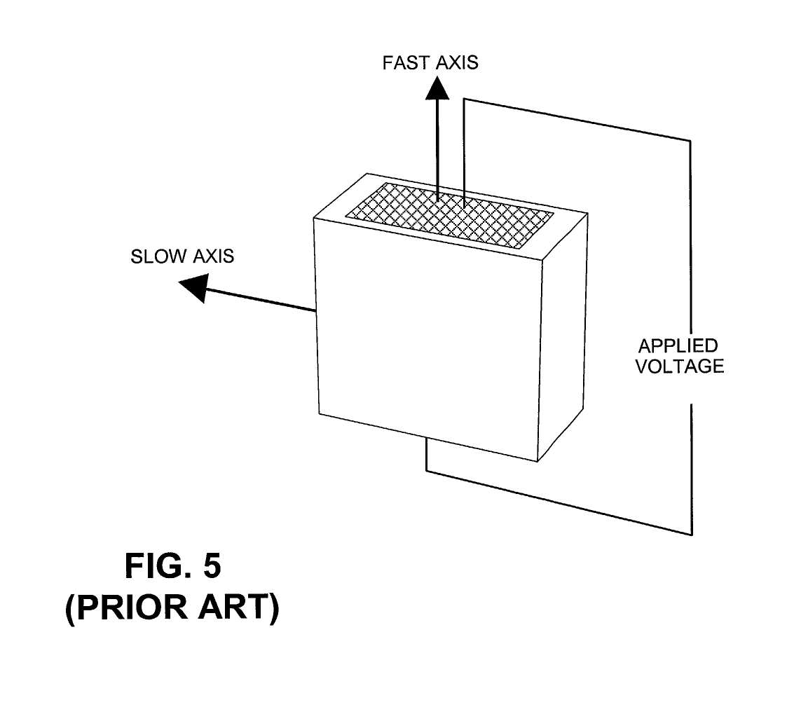

FIG. 6 shows a perspective view of a lithium niobate waveguide embedded in a substrate with three electrodes inducing a substantially horizontal field;

FIG. 6A shows the difference between variable retarders and rotatable waveplates using retardation as a function of waveplate angle;

FIG. 7 shows a perspective view of the same lithium niobate waveguide of FIG. 6 inducing a substantially vertical field;

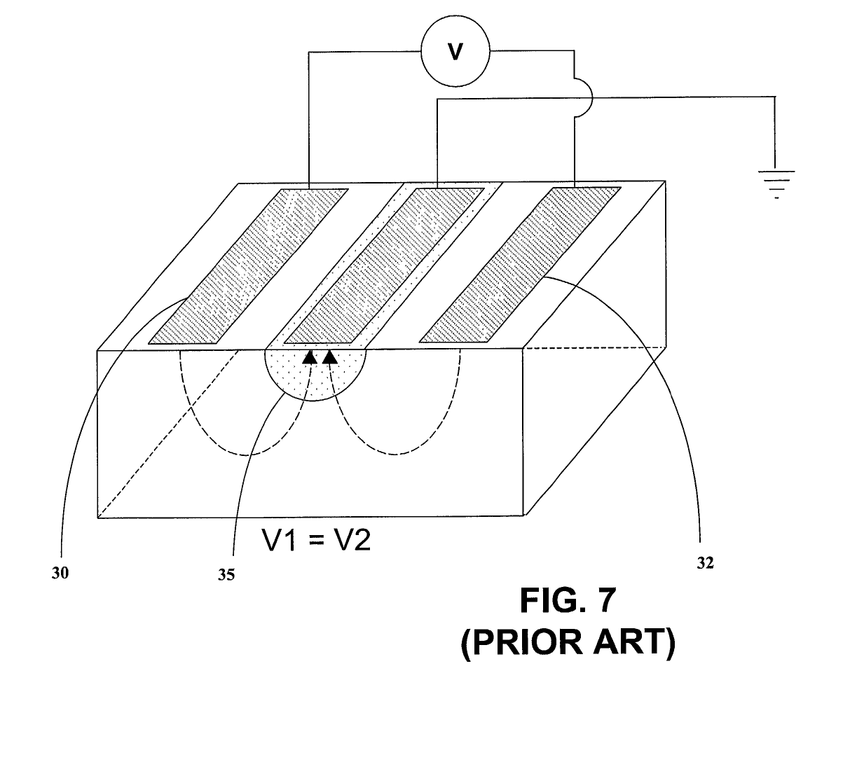

FIG. 8 shows a basic architecture for a dispersion compensated wavelength-division multiplexed transmission system;

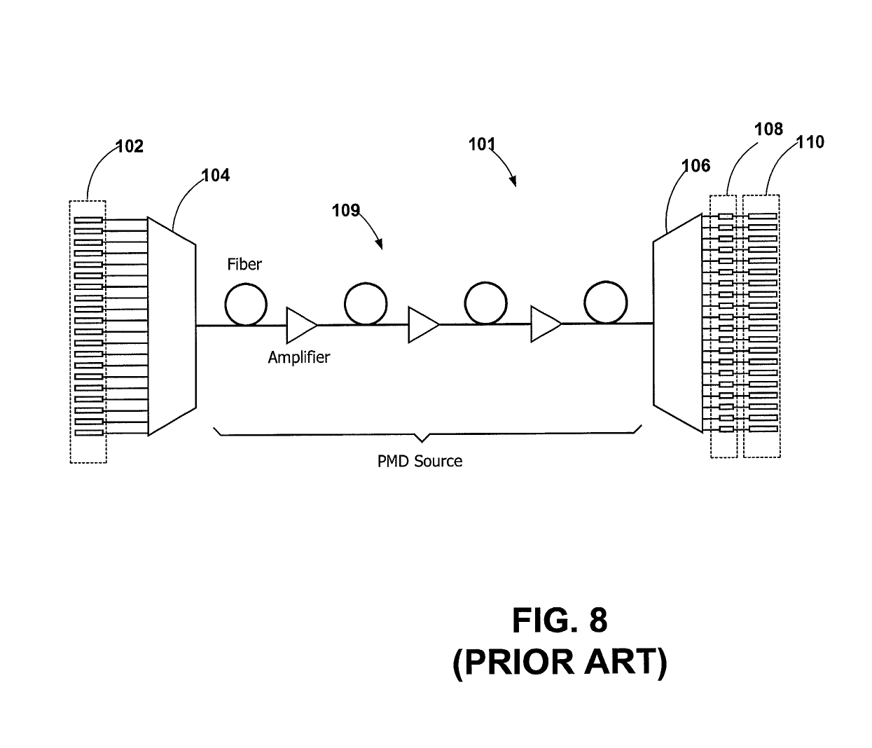

FIG. 9 shows an illustrative block diagram of a generic PMD compensator that can be used according to this invention;

FIG. 10 shows a perspective view of a four-section waveguide-based polarization transformer, where the sections have the same length, according to this invention;

FIG. 11 shows a perspective view of a six-section waveguide-based polarization transformer, where the sections have different lengths, according to this invention;

FIG. 12 shows an illustrative flow chart of a control method for a variable-step size control of angle according to this invention;

FIG. 13 shows an illustrative flow chart of a control method for a variable-step size control of retardation according to this invention;

FIG. 14 shows an illustrative flow chart of a control method for a fixed-step size control of angle according to this invention;

FIG. 15 shows an illustrative flow chart of a control method for a fixed-step size control of retardation according to this invention;

FIG. 16 shows an illustrative flow chart of a generalized control method for the variable-step size control of angle and retardation for N control sections according to this invention;

FIG. 16A shows an illustrative PMD compensator for use with a coherent dithering method according to this invention;

FIG. 16B shows an illustrative demultiplexer that can be constructed using a synchronous detection technique according to this invention;

FIG. 17 shows a test apparatus that can be used to demonstrate the effectiveness of the hybrid control method according to this invention using the polarization transformers of FIGS. 10 or 11;

FIG. 18 shows experimental data that demonstrates how hybrid polarization control according to this invention can substantially improve polarization tracking and control; and

FIG. 19 shows more experimental data comparing two histograms of detector voltages with and without hybrid control according to this invention.

### DETAILED DESCRIPTION OF THE INVENTION

Hybrid methods and apparatus for polarization control are provided. As used herein, a hybrid control section of a polarization transformer is one in which both the retardation and the angle of the section are allowed to vary.

Although this “hybrid” control can be implemented, for example, in electro-optic materials in bulk form, waveguide form, or any combination of both, other materials that allows for both retardation and angle to be varied can also be used. The angle can be varied endlessly and without any resetting. The retardation, however, can be limited to a certain retardation range, which can depend on various limitations, such as the maximum applied voltage of the voltage source, the length of the control section. By varying both the retardation and angle, fast and robust polarization transformations, tracking, and control can be achieved, even in the presence of imperfections, such as first and higher order polarization mode dispersion.

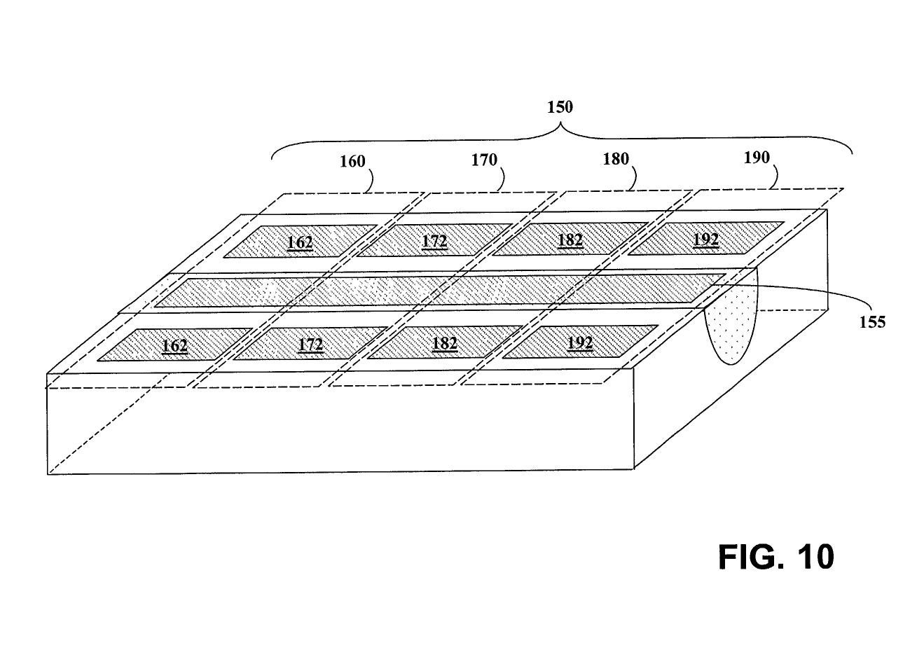

FIG. 10 shows integrated polarization transformer 150 with four discrete sections 160, 170, 180, and 190. Each of these sections can include a bulk electro-optical element or, as shown, can share a common electro-optical waveguide. Also, these sections can have the same or different physical dimensions and can be made from the same or different materials. It will be appreciated that although transformer 150 includes four control sections, a transformer according to this invention can include any convenient number of sections.

In conventional waveplate control techniques, each of sections 160, 170, 180, and 190 is driven as a “λ/n” waveplate (i.e., λ/4 or any quarter-wave waveplate). Each of waveplate sections 160, 170, 180, and 190 include pair of outer electrodes 162, 172, 182, and 192, respectively, and share common central electrode 155. In an alternate embodiment, each section could have a separate central electrode. By applying appropriate voltages (V₁, V₂) to each pair of outer electrodes, each section can be effectively rotated to arbitrary waveplate angle α. According to one control scheme, the magnitude of the applied voltages can be:

V₁=Γ[A sin(α)+B cos(α)]+C, and

V₂=Γ[A sin(α)−B cos(α)]−C,

where A, B, and C are substantially fixed voltages (they may vary somewhat with temperature), and Γ is the desired waveplate retardation. To ensure precise angular control, fixed voltages A, B, and C are preferably known to a high degree of accuracy.

In contrast to conventional control schemes, and according to this invention, retardation Γ and waveplate angle α are allowed to vary for at least one of sections 160, 170, 180, and 190. The retardation can be constrained to vary within certain limits. By varying both retardation Γ and angle α of a control section (within a polarization transformer), polarization control performance improves significantly.

A “hybrid” control section, then, is any control section that allows both retardation and angle to vary. Angle and retardation can vary simultaneously or alternatingly, as well as periodically or continuously. If a polarization transformer includes at least one hybrid section according to this invention, then the polarization transformer is referred to as a “hybrid” polarization transformer.

There are a number of different hybrid control configurations according to this invention. Some of these are included in TABLE I (below) for four-section polarization transformer 150 of FIG. 10. It will be appreciated that additional configurations having different numbers of sections and different retardation value limits can also be used according to this invention.

To compactly describe these configurations, the following notation is adopted. First, when the retardation value of a section is variable, that value can be varied between a low retardation value “L” to a high retardation value “H.” In this way, general control of a four-section transformer can be described generally as (L₁H₁)-(L₂H₂)-(L₃H₃)-(L₄H₄), where Lᵢ and Hᵢ can be different for each of the four sections.

Second, L and H are given simply as multipliers of the design retardation of a control section. For example, when the design retardation of a control section is a quarter-wave of retardation, the lower retardation limit equals L*(λ/4) and the higher retardation limit equals H*(λ/4). Thus, when L=1 and H=2, the retardation value of a section can vary between a quarter-wave and a half-wave of retardation. Similarly, when L H, then the section has a fixed retardation and permits only the angle to vary (such a section, therefore, would not be a hybrid). As shown in the table below, multipliers L and H need not be integers according to this invention.

Finally, the notation assumes that all sections have an endlessly variable waveplate angle. It will be appreciated, however, that every control section need not have a variable angle and, if variable, it need not be endless.

As used herein, the term “design” retardation refers to a manufacturer's recommended retardation value of a control section (for a specified optical wavelength). For example, JDS Uniphase Corporation, of Bloomfield, Conn., sells a polarization control device using an eight section z-propagating waveguide on x-cut lithium niobate, which is currently sold under Part No. 21001106. In this device, each of the polarization stages has a design retardation of an eighth-waveplate at 1550 nm. The design retardation is based on the recommended, or design, operating voltages Vₒ, V_{π}, and V_{bias}. Vₒ is the voltage required to convert all power in the TE mode to the TM mode and vice versa. V_{π} is the voltage required to induce a 180 degree phase shift between the TE and TM polarization modes. And, V_{bias} is the voltage required to maintain zero birefringence between the TE and TM polarization modes. Each control section of the JDS polarization controller has design voltages of Vₒ˜48 volts and V_{π}˜107 volts. V_{bias} can vary substantially, depending on its location with the device and other factors.

TABLE I shows a number of conventional control configurations for the four-section device of FIG. 10. The terms “1/4” and “1/2” refer to control sections that act as quarter-wave and half-wave waveplates, respectively.

TABLE I

| | | Con- | |
|---|---|---|---|
| | | struc- | |
| No. | Notation | tion | Operation |
| 1 | (1/1)-(1/1)- | ¼-¼- | Each of the four sections has a fixed |
| | (1/1)-(1/1) | ¼-¼ | retardation (equal to a QWP) and allows |
| | | | only angle to vary. |
| 2 | (1/1)-(2/2)- | ¼-½- | Each of the four sections has a fixed |
| | (1/1)-(2/2) | ¼-½ | retardation (1st and 3rd equal to a QWP, |
| | | | 2nd and fourth equal to a HWP) and |
| | | | allows only angle to vary. Because all |
| | | | four sections are the same, the 2nd |
| | | | and 4th sections are controlled using a |
| | | | maximum voltage twice that of other |
| | | | sections. |

In contrast to TABLE I, and according to this invention, TABLE II shows a number of hybrid control configurations for the same four-section device. Again, the terms “1/4” and “1/2” refer to control sections that act as quarter-wave and half-wave waveplates, respectively. In addition, the term “H” has been introduced to refer to a hybrid control section.

TABLE II

| | | Con- | |
|---|---|---|---|
| | | struc- | |
| No. | Notation | tion | Operation |
| 3 | (1/1)-(1/2)- | ¼-H- | 1st and 3rd sections have a fixed |
| | (1/1)-(1/2) | ¼-H | retardation equal to a QWP. 2nd and |
| | | | fourth sections are hybrid sections and |
| | | | have a variable retardation |
| | | | between a QWP and a HWP. |
| 4 | (1/2)-(1/1)- | H-¼- | 1st and 3rd sections are hybrid sections |
| | (1/2)-(1/1) | H-¼ | and have a variable retardation between a |
| | | | QWP and a HWP. 2nd and 4th sections |
| | | | have a fixed retardation equal to a QWP. |
| 5 | (1/2)-(1/2)- | H-H- | All sections are hybrid and have a variable |
| | (1/2)-(1/2) | H-H | retardation between a QWP and a HWP. |
| 6 | (.5/1.5)- | H-H- | All sections are hybrid and have a variable |
| | (.5/1.5)- | H-H | retardation between 0.5 and 1.5 times a |
| | (.5/1.5)- | | quarter wave of retardation. |
| | (.5/1.5) | | |
| 7 | (.7/1.2)- | H-H- | All sections are hybrid and have a variable |
| | (.7/1.2)- | H-H | retardation between 0.7 and 1.2 times a |
| | (.7/1.2)- | | quarter wave of retardation. |
| | (.7/1.2) | | |
| 8 | (.5/1)-(.5/1)- | H-H- | All sections are hybrid and have a variable |
| | (.5/1)-(.5/1) | H-H | retardation between 0.5 and 1 times a |
| | | | quarter wave of retardation. |
| 9 | (−1/1)- | H-H- | All sections are hybrid and have a variable |
| | (−1/1)- | H-H | retardation between −1 and 1 times a |
| | (−1/1)-(−1/1) | | quarter wave of retardation |
| 10 | (1/1.5)-(1/1)- | H-¼- | 1st and 3rd sections are hybrid and have a |
| | (1/1.5)-(1/1) | H-¼ | variable retardation between 1.0 and 1.5 |
| | | | times a quarter wave of retardation. 2nd |
| | | | and 4th sections have a fixed retardation |
| | | | equal to a QWP. |
| 11 | (.5/1.5)- | H-¼- | 1st and 3rd sections have a variable |
| | (1/1)- | H-¼ | retardation between 0.5 and 1.5 times a |
| | (.5/1.5)-(1/1) | | quarter wave of retardation. 2nd and |
| | | | 4th sections have a fixed |
| | | | retardation equal to a QWP. |
| 12 | (.5/1)- | H-¼- | 1st and 3rd sections have a variable |
| | (1/1)- | H-¼ | retardation between 0.5 and 1.0 times a |
| | (.5/1)-(1/1) | | quarter wave of retardation. 2nd and |
| | | | 4th sections have a fixed |
| | | | retardation equal to a QWP. |

Preferably, the sum of the maximum retardations of a polarization transformer is equal to or greater than a full wave of retardation. More preferably, the sum of the minimum retardations of the transformer is equal to or greater than a full wave of retardation. Moreover, it will be appreciated that configuration No. 9 shows how a section can have a variable retardation that can include negative, as well as positive, values.

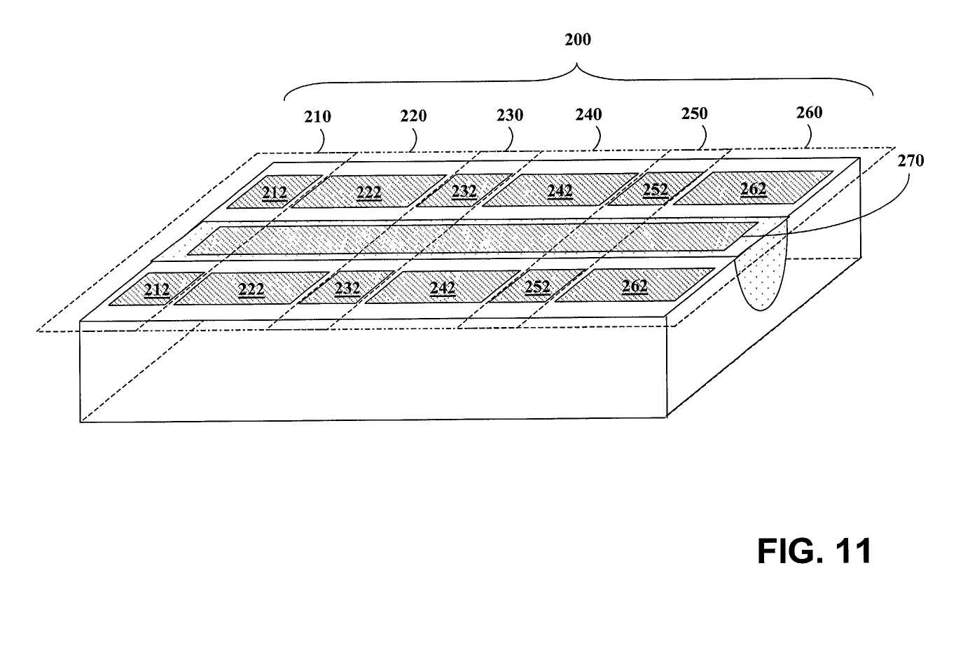

FIG. 11 shows another illustrative embodiment of polarization transformer 200 in accordance with this invention. Transformer 200 includes a repeating cascade of alternating length sections 210, 220, 230, 240, 250, and 260. Each of these sections can be constructed from a bulk electro-optical element or, as shown, can share a common electro-optical waveguide. Each of these waveplate sections also include pair of outer electrodes 212, 222, 232, 242, 252, and 262, respectively, and share common central electrode 205. In an alternate embodiment, each section could have a separate central electrode. Although transformer 200 includes an “alternating” length profile, where the lengths vary periodically, it will be appreciated that such a periodic variation is unnecessary according to this invention. Rather, the exact length profile is only governed by the polarization transformer design criteria.

Whenever |L|>1 or |H|>1, the voltage applied to the section is greater than its design voltage. As used herein, and as explained above, the design voltage of a control section is the manufacturer's recommended applied voltage to achieve its design retardation. It will be appreciated, then, that one can avoid applying voltages greater than the design voltage by varying the dimensions of some sections, such as by making some sections longer than others.

Therefore, control sections with different lengths can have different retardation ranges, even though each of the sections operates below its particular design voltage. So, if apparatus 200 has a control configuration of (0.5/1)₁-(0.5/1)₂-(0.5/1)₁-(0.5/1)₂-(0.5/1)₁-(0.5/1)₂, where each subscript refers to the relative length of each section, then alternating control sections will have retardation ranges that are twice the range of the others. It will be appreciated that although the ratio of lengths l₁ and l₂ is 1/2 in FIG. 11, the ratio can be larger or smaller than 1/2, depending on the particular retardation limits desired.

Design considerations, other than the length of the control section, can also be tailored to achieve the appropriate retardation range, including cross-sectional dimensions, the birefringent material, and electrode placement.

Virtually any control method that varies both the retardation and angle of a control section can improve the speed of the polarization controller according to this invention.

One category of control methods according to this invention includes steepest gradient algorithms. At least three different types of steepest gradient algorithms that can be used in accordance with this invention are: (1) the variable-step size gradient algorithm, (2) the fixed-step size gradient algorithm, and (3) the coherent dither algorithm. Retardation and angle of a single control section can be varied serially or in parallel. Similarly, different control sections within a single polarization transformer (e.g., controller) can be controlled serially or in parallel. The coherent dither algorithm can be particularly well suited for certain parallel control schemes. It will be appreciated that other types of control algorithms, other than steepest gradient algorithms, can be also used in accordance with this invention.

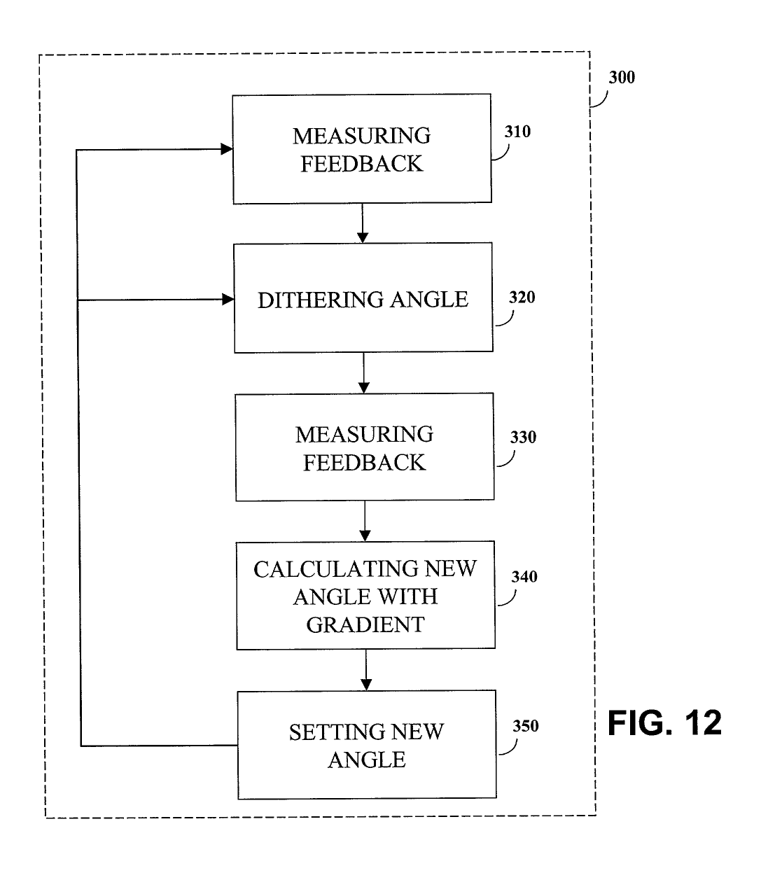

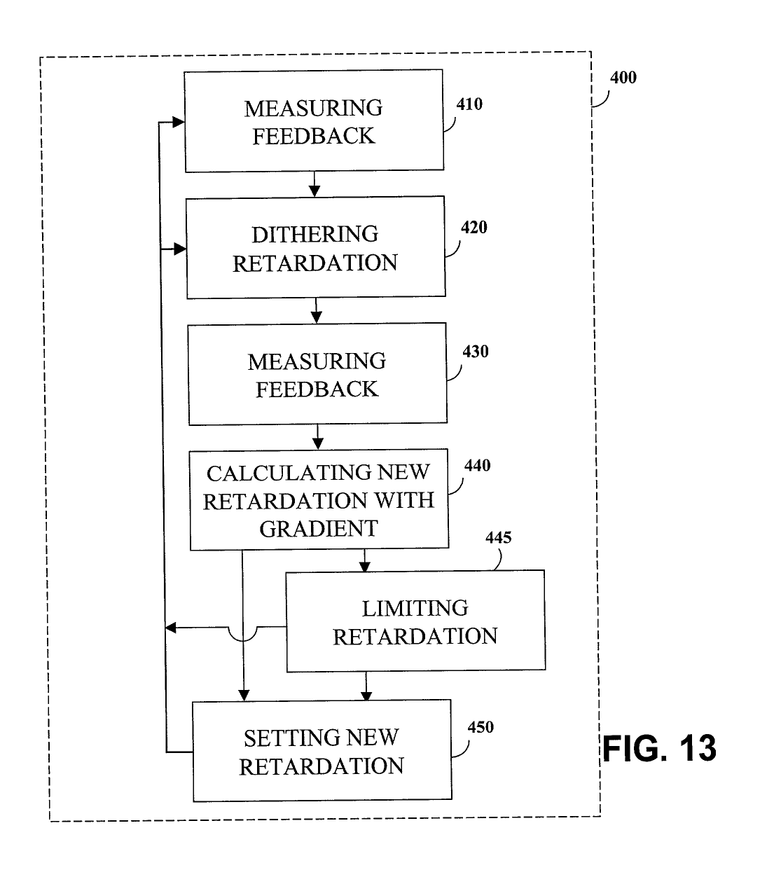

FIG. 12 shows an illustrative flow chart of control method 300 for the variable-step size control of a section's angle according to this invention. Similarly, FIG. 13 shows an illustrative flow chart of control method 400 for the variable-step size control of a section's retardation according to this invention. When combined to control a single section of a polarization transformer, these methods have been found to improve polarization control significantly.

In variable-step size algorithms, a full gradient is usually calculated for each control step. Thus, such an algorithm requires at least two feedback values (at least two data acquisitions), before making a control step. The size of each control step depends on the magnitude of the measured gradient and a feedback, or gain, constant ρ. Such an algorithm can be particularly stable because the size of the control step can be made relatively small, especially when the algorithm has optimized each control step. As explained above, retardation of a section cannot be controlled endlessly and, therefore, retardation control differs from angular control. This difference will be explained more fully below.

Angular control method 300 can include (1) measuring feedback in step 310, (2) dithering angle in step 320, (3) measuring feedback again in step 330, (4) calculating new angle based on gradient in step 340, and (5) setting a new angle in step 350.

The measurement of feedback in step 310 can involve sampling a feedback value once, or sampling the feedback multiple times and then averaging. It will be appreciated, however, that any feedback data acquisition algorithm can be used in accordance with this invention, including continuous, as well as periodic, techniques.

An acceptable feedback signal, when used in an optical distortion compensator, for example, can be one that characterizes an optical signal quality. Copending, commonly owned Pacek U.S. Provisional Patent Application No. 60/268,944, filed Feb. 15, 2001, which is hereby incorporated by reference in its entirety, shows that the quality of an EYE diagram can be used as a feedback signal.

Dithering of control section angle θ in step 320 can involve varying the angle in one direction by a fixed dithering step size or by a variable step size. Moreover, the direction of the dither can be fixed or variable. For example, the direction of the dither can depend on the previous angle adjustment, or setting, in step 350.

In any case, by dithering the angle, an SOP transformation can take place, which may cause the feedback measurement in step 330 to be different from the feedback measurement made in step 310. Again, it will be appreciated that any type of feedback measurement can be made in step 330 in accordance with this invention.

An updated or new angle can be calculated in step 340 using a gradient based on the feedback measurements made in steps 310 and 330. According to one embodiment, the angle can be calculated as a function of initial angular value θₒ, angular gain feedback constant ρ_{θ}, change in the feedback value ΔFB, and the size of angular dither step Δθ. In one embodiment, a new angle can be calculated substantially according to the following equation:

θ=θₒ+MOD(ρ_{θ}*ΔFB−Δθ)

It will be appreciated that other methods of calculating angle can also be used according to this invention.

As briefly discussed above, FIG. 13 shows an illustrative flow chart of control method 400 for the variable-step size control of a section's retardation according to this invention. Retardation control method 400 can include (1) measuring feedback in step 410, (2) dithering retardation in step 420, (3) measuring feedback again in step 430, (4) calculating new angle based on gradient in step 440, and (5) setting a new retardation in step 450.

The measurements of feedback in steps 410 and 430 can be the same as the measurements made in steps 310 and 330. Also, like the dithering of angle in step 320, dithering of retardation Γ in step 420 can have a variable size and/or direction. In any case, by dithering the retardation, an SOP transformation can take place, which may cause the feedback measurement in step 430 to be different from the feedback measurement made in step 410.

An updated or new retardation can be calculated in step 440 using a gradient based on the feedback measurements made in steps 410 and 430. According to one embodiment, the retardation can be calculated as a function of initial retardation value Γₒ, retardation gain feedback constant ρ_{Γ}, change in the feedback value ΔFB, and the size of retardation dither step Δθ. In one embodiment, a new retardation can be calculated substantially according to the following equation:

Γ=Γₒ+ρ_{Γ}*ΔFB−ΔΓ.

It will be appreciated that other methods of calculating retardation can also be used according to this invention.

Retardation control is different from angle control because retardation of a single section cannot be controlled endlessly. As a result, before method 400 sets the retardation of a control section in step 450 to the retardation value calculated in step 440, method 400 can check the calculated value to ensure that it does not fall outside of an allowable retardation range in step 445. If the calculated retardation value does fall outside of an allowable range (below L or above H), the value can be reset to L or H, as needed. In an alternative embodiment, step 445 could be integrated into the retardation calculation in step 440.

Alternatively, the value can be recalculated using, for example, a look-up table, or an analytically or empirically derived formula. It will be appreciated that the recalculation can be based on two or more control sections. Moreover, the allowable retardation values may be linked to particular angular rotational values. This linkage could speed performance by eliminating undesirable polarization transformations.

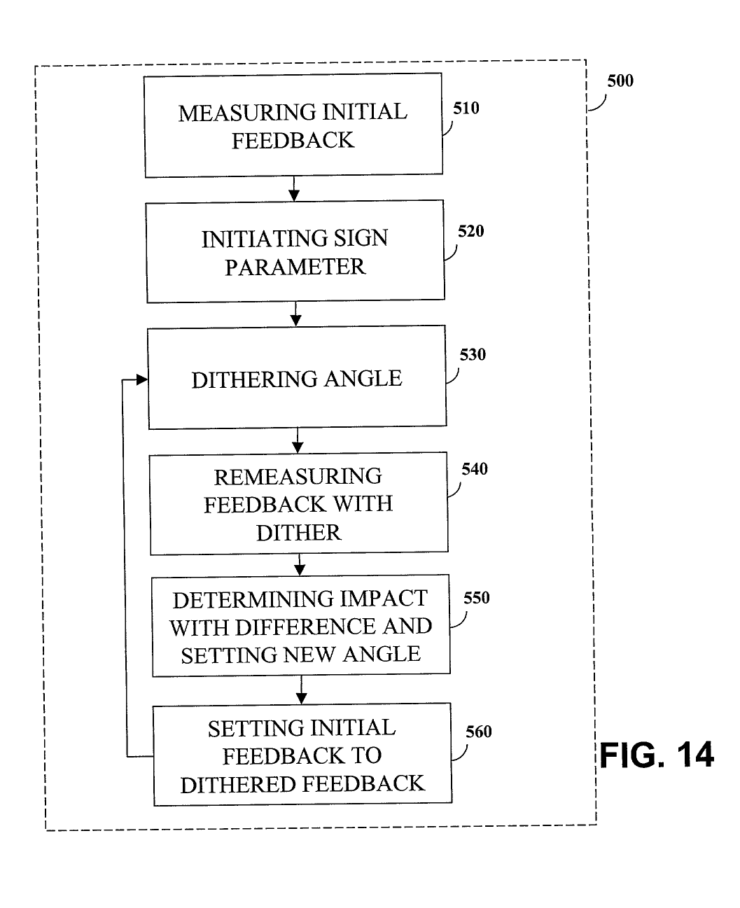

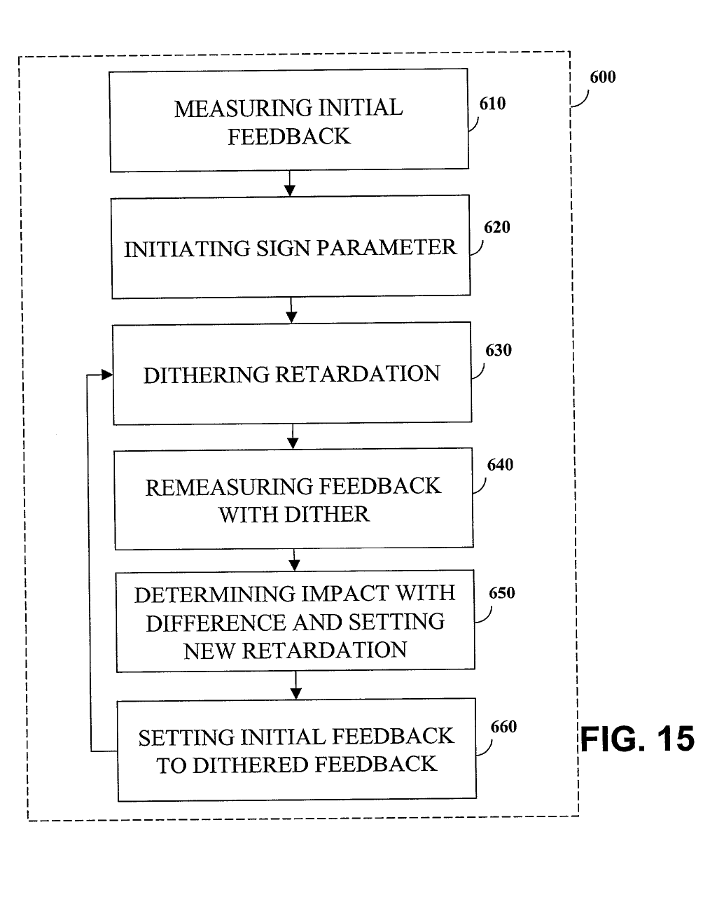

FIG. 14 shows an illustrative flow chart of control method 500 for the fixed-step size control of angle according to this invention. Similarly, FIG. 15 shows an illustrative flow chart of control method 600 for the fixed-step size control of retardation according to this invention. When combined to control a single section of a polarization transformer, these methods have been found to improve polarization control significantly. It will be appreciated that a hybrid polarization control scheme according to this invention can combine two fixed-step size control methods, two variable-step size control methods, or a combination of a fixed-step size and variable-step size control methods.

In a fixed-step size algorithm, the sign of the gradient is used, even though the size of the control step remains fixed. Because the magnitude of the control step is fixed, the algorithm only calculates a difference and only one feedback value (i.e., acquisition event) is required for each control step. Thus, a fixed-step size algorithm can be, in some cases, twice as fast as the variable-step size algorithm.

There is generally a tradeoff, however, between an algorithm's speed and stability. High stability can be achieved with control steps that cause small changes in the feedback parameter. Small changes, however, generally lead to reduced control speeds.

Returning to FIG. 14, control method 500 is for the fixed-step size control of angle according to this invention. Angular control method 500 can include (1) measuring initial feedback in step 510, (2) initializing a SIGN parameter (i.e., “+” or “−”) in step 520, (3) dithering angle in step 530, (4) remeasuring feedback in step 540, (5) determining impact based on calculated difference in step 550, and (6) setting initial feedback value equal to remeasured feedback value in step 560.

The measurements of initial and dithered feedback in steps 510 and 540 can be the same measurements made in steps 310 and 330. Also, like the dithering of angle in step 320, dithering of angle in step 530 can have a variable-step size and direction, although in this case it has a fixed-step size. The direction can be determined by the SIGN parameter, for example, as follows:

θ=θₒ+MOD(SIGN*Δθ, 2π),

where Δθ is a fixed-step of dithering angle and the direction of the dither is based on the value of the SIGN parameter.

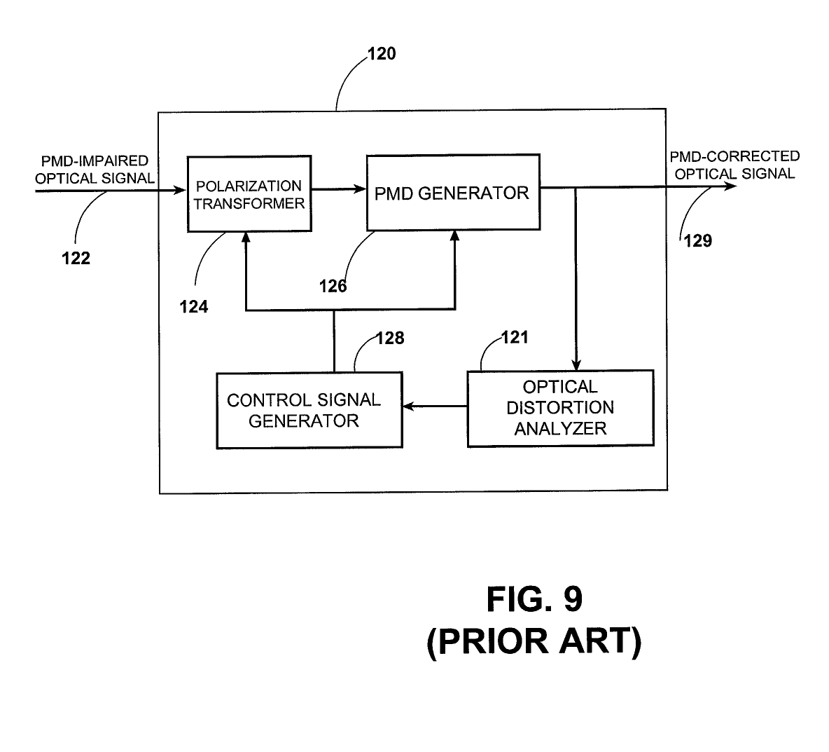

Like the methods shown in FIGS. 9 and 10, dithering angle in step 530 can cause an SOP transformation of the control section, which may further cause a feedback measurement in step 540 to be different from the initial feedback measurement made in step 510. The impact of the dithering can be determined in step 550, for example, as follows:

SIGN=SIGN*sign(FB_{d}−FBᵢ)

where FB_{d} is the feedback measurement made in step 540, FBᵢ is the initial feedback measurement (e.g., made initially in step 510 or in a previous feedback loop in step 560). According to this impact calculation, the value of the SIGN parameter is updated based on whether the impact of the feedback measurement was found to positive or negative.

FIG. 15 shows an illustrative flow chart of control method 600 for the fixed-step size control of retardation according to this invention. Retardation control method 600 can include (1) measuring initial feedback in step 610, (2) initializing a SIGN parameter (i.e., “+” or “−”) in step 620, (3) dithering retardation in step 630, (4) remeasuring feedback in step 640, (5) determining impact based on calculated difference in step 650, and (6) setting initial feedback value equal to remeasured feedback value in step 660.

Control method 600 is like control method 500, except that, as discussed above, retardation control should take into account the non-endless nature of any particular section. Accordingly, before method 600 dithers the retardation of a control section in step 630, method 600 can check the next retardation value to ensure that it does not fall outside of an allowable retardation range. If the next retardation value does fall outside of an allowable range (below L or above H), the value can be it reset to L or H, as needed, or recalculated as described above.

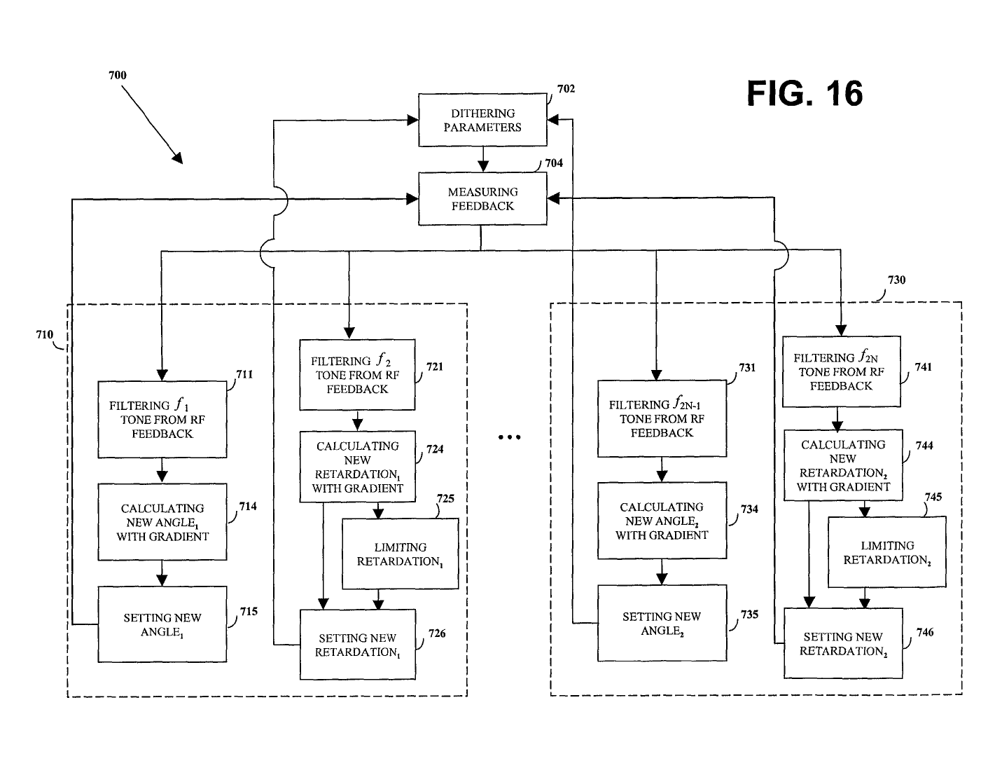

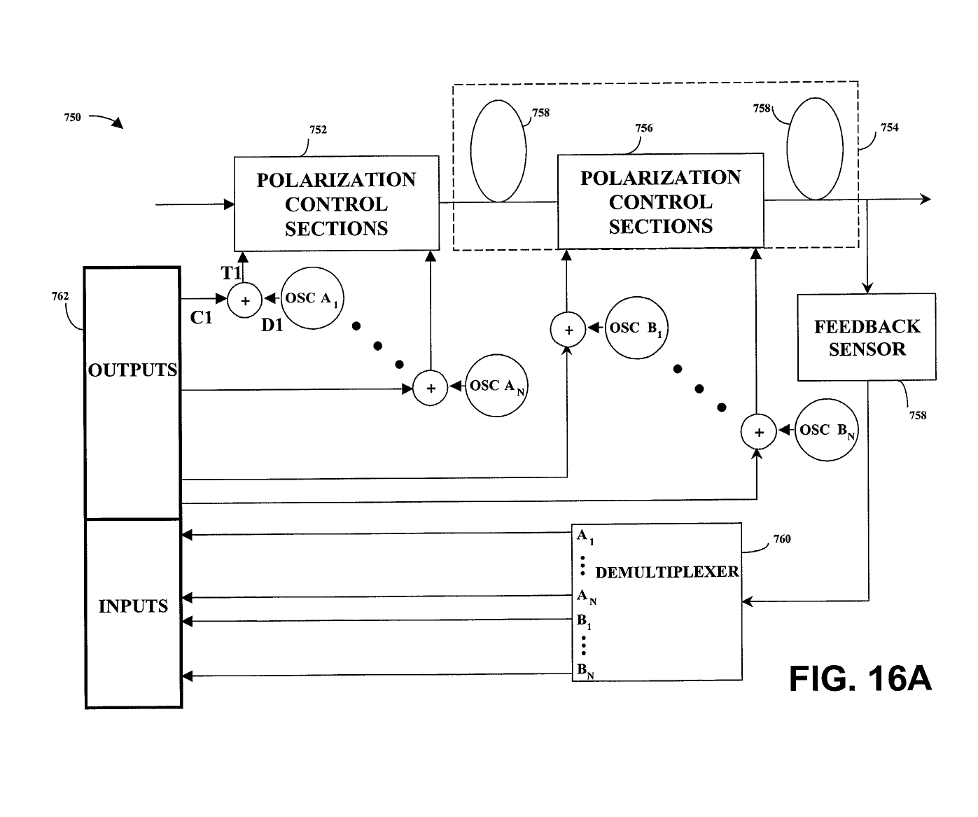

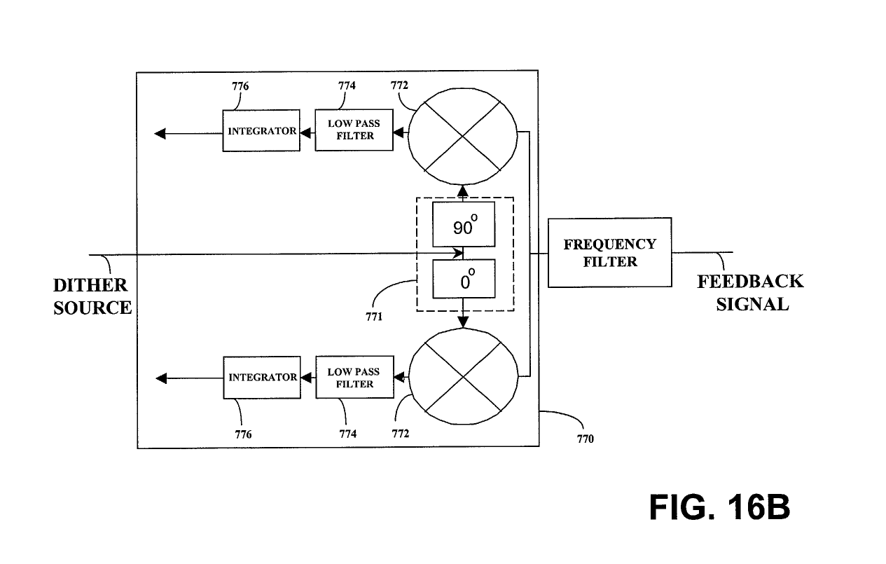

FIG. 16 shows an illustrative flow chart for coherent dither method 700 according to this invention. In method 700, each controlled parameter is perturbed with a unique tone fᵢ. If there are N control sections, then there would be a maximum of 2N control parameters—N retardation parameters and N angle parameters. In order to perform a coherent dither method according to this invention, retardation and angle must be controlled in at least one control section. Thus, although algorithm 700 controls all 2N parameters, it will be appreciated that any number of control sections may be operated as a hybrid control section according to this invention.

By calibrating the closed-loop response of the system, the response to the perturbation associated with fᵢ can be isolated and both the magnitude and phase information of the gradient can be extracted from the response. Furthermore, the tones can be multiplexed in the frequency or time domains. An advantage of multiplexing in the frequency domain is that multiple control algorithms can be performed in parallel (i.e., simultaneously), thereby allowing a significant speed increase in the overall close-loop response.

Another advantage of the coherent dither method, whether in the time or frequency domain, is that each tone can be phase locked. Phase locking can provide coherent gain to the feedback and can improve the signal-to-noise ratio of the system.

For example, in control method 700, at least two control parameters are dithered at different frequencies in step 702. In one embodiment, all parameters are dithered simultaneously, but, as described above, can be dithered periodically, serially, or according to any other convenient scheme. By dithering at different frequencies, however, pure simultaneous dithering of multiple parameters is possible, as long as the feedback measurement, made in step 704, can be filtered, in steps 711, 721, 731, and 741, to separately extract the respective signals. It will be appreciated that when phase locking techniques are used according to this invention, measuring and filtering are essentially performed simultaneously.

The magnitude of the filtered signals can then be analyzed and a new angle or retardation step can be calculated based on the filtered signal. The magnitude of the filtered signal is generally indicative of the effect of the dithering and, thus, is like a gradient. Thus, in calculating steps 714, 724, 734, and 744, calculation of new retardations and angles can be based on those filtered gradient values. When the control parameter is retardation, then the calculated value can be limited in steps 725 and 745, as previously explained.

After calculating a new control parameter, the respective control section can be reset to the new calculated value in steps 715, 726, 735, and 746. If dithering is performed continuously through the control process, then after resetting in steps 715, 726, 735, and 746, the method can remeasure the feedback signal in step 704 and filtering in steps 711, 721, 731, and 741 can again take place. If dithering is not continuously performed throughout the control process, method 700 must return to dithering in step 702 before a new feedback measurement can be made in step 704.

FIG. 16A shows an illustrative PMD compensator for use with coherent dithering method 700. Compensator 750 includes initial polarization transformer 752 (which may contain multiple polarization transformation control sections), PMD generator 754, feedback sensor 758, demultiplexer 760, and optical distortion analyzer and controller 762.

PMD generator can include two or more birefringent elements 758, such as polarization maintaining fibers, and intermediate polarization transformer 756.

One difference between PMD compensators 120 and 750 is that analyzer 121 includes an integrated feedback sensor that converts an optical signal into an electrical one. By separating sensor 758 from controller 762, demultiplexer 760 can be inserted in the feedback signal line after sensor 758. Demultiplexer can include a bank of filters specific to each control signal dither characteristic. It will be appreciated that these filters could be implemented digitally using numeric methods after the input signal is digitized, or by analog means using active or passive filter designs.

As shown in FIG. 16A, control signals (e.g., C1) and dither signals (e.g., D1, provided by oscillators) can be summed and that the resultant sum (e.g., T1) can be applied to the individual control sections of a transformer. This can be repeated for all control signals, if desired. Offset signals can also be provided (e.g., within controller 762) to provide a particular voltage offset. It will be appreciated that each of the oscillators shown in FIG. 16A can also be integrated into controller 762.

FIG. 16B shows demultiplexer 770, which can be constructed using synchronous detection techniques. In this embodiment, the demultiplexer can include a quadrature hybrid 771 (or equivalent) coupled to a dithering source for supplying a phase shift (e.g., 90 degrees) between two output signals, two mixers (i.e., multipliers) 772 that provide DC and higher order frequency products, two low pass filters 774 that selects the DC terms from respective multipliers 772, and optional integrators 776 that can be used to average the output and reduce the noise. It will be appreciated that mixers 772 can be constructed using an analog mixing device or a switched capacitor topology for analog constructions.

During operation, quadrature hybrid 771 samples the original dither signal source and mixes it with the feedback signal source in quadrature. This provides two significant benefits. First, detection improves, especially under noisy conditions, because of the coherent signal detection. Second is the availability of the complex real/imaginary signal output. Instead of having only one signal output per control device there are now two, one of which reveals the sign of the dither derivative. Thus, if increasing the primary control signal decreases the feedback signal, the direction information from complex detection will reveal this. This is in contrast to when the feedback signal is varied in phase with the control signal (i.e., increasing feedback signal with increasing control signal).

It will be appreciated that the hybrid control algorithms taught above are illustrative only and that several variations of these algorithms could be used in accordance with this invention, including frequency modulation with simultaneous phase sensitive detection schemes.

Any optical device requiring polarization control can use the hybrid control techniques of this invention. In particular, closed-loop, dynamic feedback systems that must respond quickly and accurately to changing conditions will especially benefit. For example, a PMD compensator built according to this invention can include a hybrid polarization transformer, an optical distortion analyzer, and a control signal generator. As shown in FIG. 9, a compensator can also include a PMD generator. That generator can include one or more hybrid control sections according to this invention. As explained above, the polarization transformer and the PMD generator can be controlled such that the optical output suffers minimal PMD impairment. It will be appreciated that, while not all PMD compensators have an input transformer, some form of transformer is generally required and can be combined with the generator.

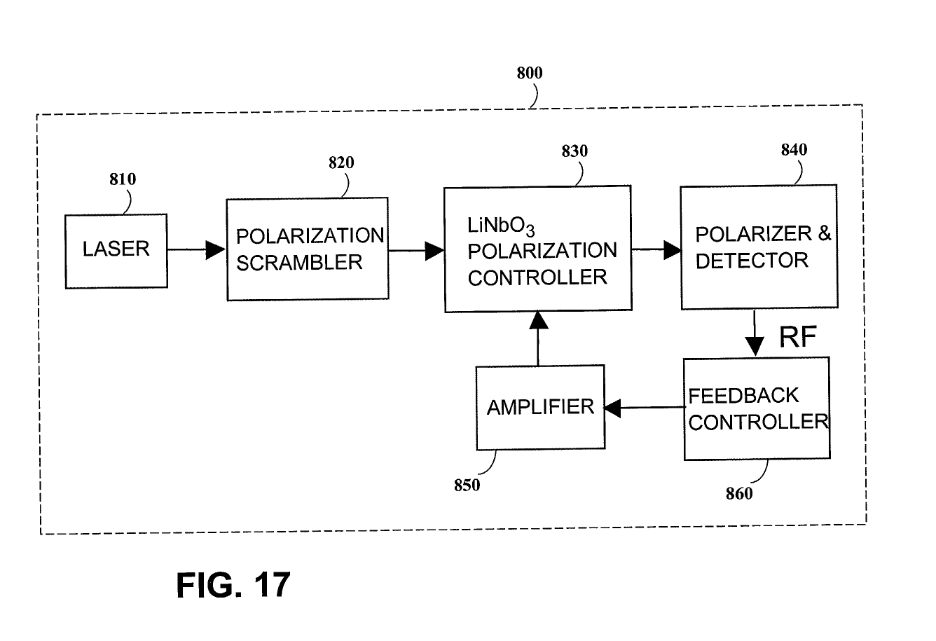

FIG. 17 shows test apparatus 800 that can be used to demonstrate the effectiveness of the hybrid control method according to this invention using polarization controller 150 of FIG. 10. In this experiment, laser 810 provides a polarized laser beam and polarization scrambler 820 receives the beam and changes the beam's SOP at a certain scrambling speed. Thus, without any feedback, the SOP of the light beam at the output of controller 830 varies with time, thereby causing the amount of light transmitted to and detected by polarizer and detector unit 840 to fluctuate at the scrambler speed.

Feedback controller 860 operates using a feedback control algorithm based on an RF signal indicative of the amount of light transmitted to unit 840. The algorithm can either maximize or minimize the value of the RF by driving polarization controller 860 with a hybrid control scheme according to this invention. Thus, it will be appreciated that if the output of controller 830 is a substantially constant SOP aligned with the polarizer of unit 840, a substantially constant RF signal will be provided to controller 860. Amplifier 850 was used to amplify the control signals provided to controller 830.

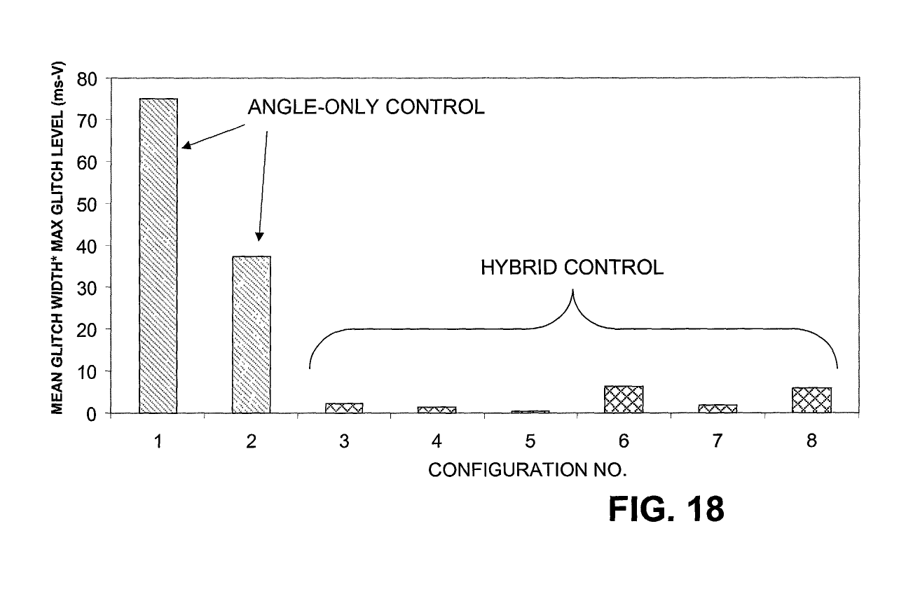

FIG. 18 shows experimental performance data acquired using test apparatus 800 to compare conventional angle-only control methods (configuration Nos. 1 and 2 of TABLE I) with various hybrid polarization control methods (configuration Nos. 3-8 of TABLE II) according to this invention. As stated above, a substantially constant RF signal should be provided to controller 860 during polarization control, even as the input SOP varies rapidly. Therefore, one measure of the effectiveness of a control scheme according to this invention is the time spent substantially away from a desired maximum or minimum voltage. Accordingly, a glitch is said to occur whenever the voltage crosses a particular voltage threshold and reaches a particular glitch voltage level. Furthermore, a glitch having a long duration is worse than a glitch having a short duration. Thus, the “width” of a glitch is the amount of time spent on the undesired side of the glitch threshold.

The data shown in FIG. 18 was taken when the polarization control algorithms sought to minimize the detector voltage. The performance metric used is a product of the mean glitch width and the max glitch level (msec-V). That is, the product of the average time spent above the glitch level and the maximum level reached. Thus, low values of our performance metric (i.e., figure of merit) are desirable. FIG. 18 shows that hybrid control methods according to this invention substantially improve polarization tracking and control.

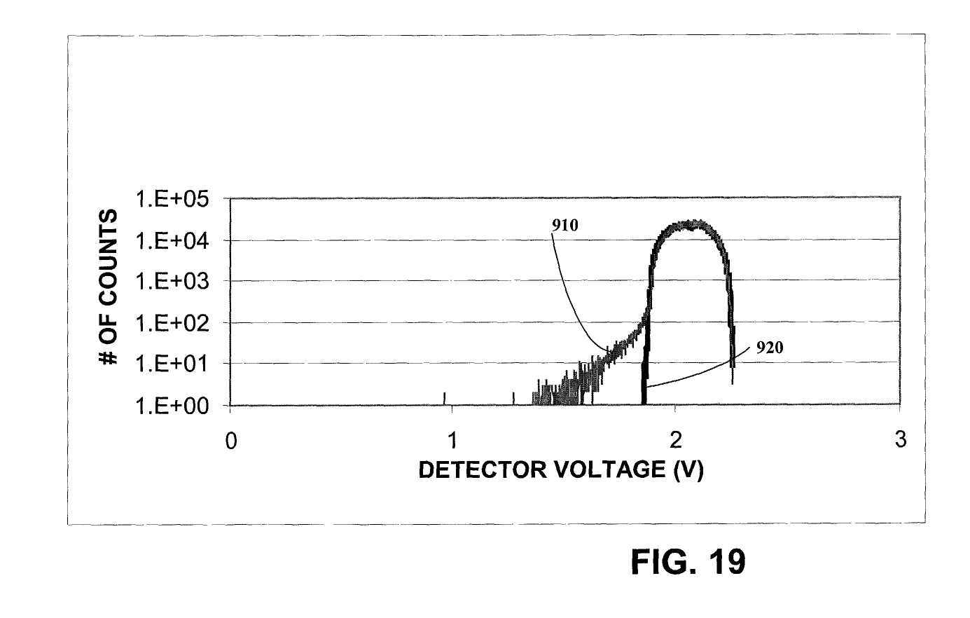

Because test system 800 of FIG. 17 attempts to maintain the detector voltage at a substantially constant value, the range of voltages measured at detector 840 can serve as a performance metric. FIG. 19, then, shows two histograms of detector voltages with hybrid control (see, Configuration No. 5 of Table II) and (2) without hybrid control, where only the angles were allowed to rotate endlessly (See Configuration No. 1 of Table I). Comparison of hybrid histogram 920 with non-hybrid histogram 910 reveals that hybrid control according to this invention narrows the range of detector voltages from between about 1.4 volts and about 2.3 volts, to between about 1.8 and 2.3 volts. The reduced range shows that the hybrid technique according to this invention provides significantly better polarization control than the non-hybrid technique.

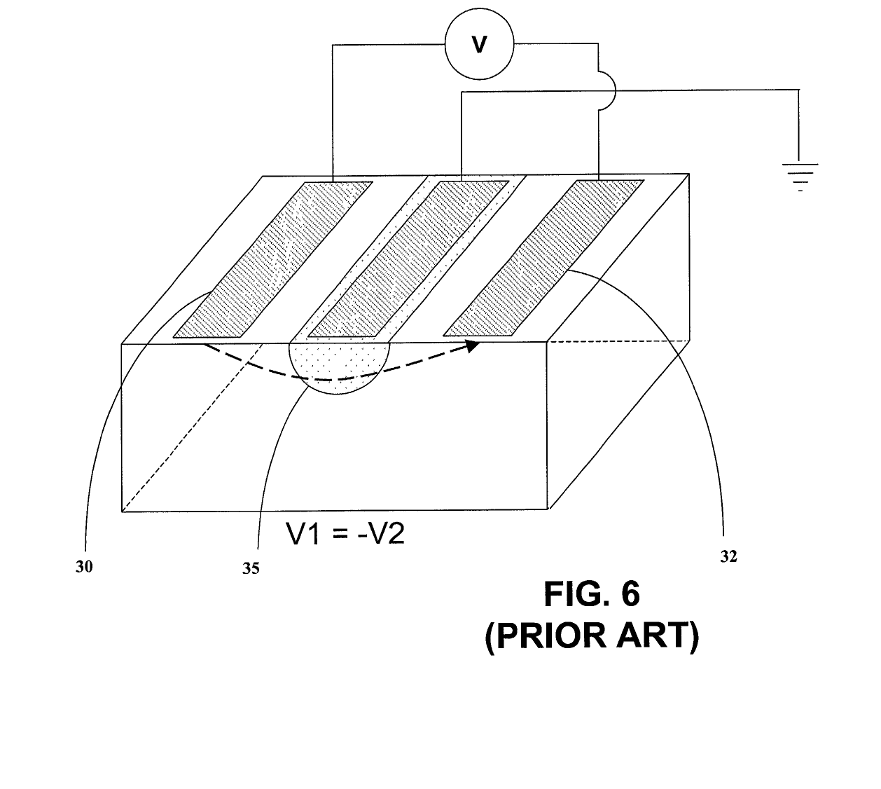

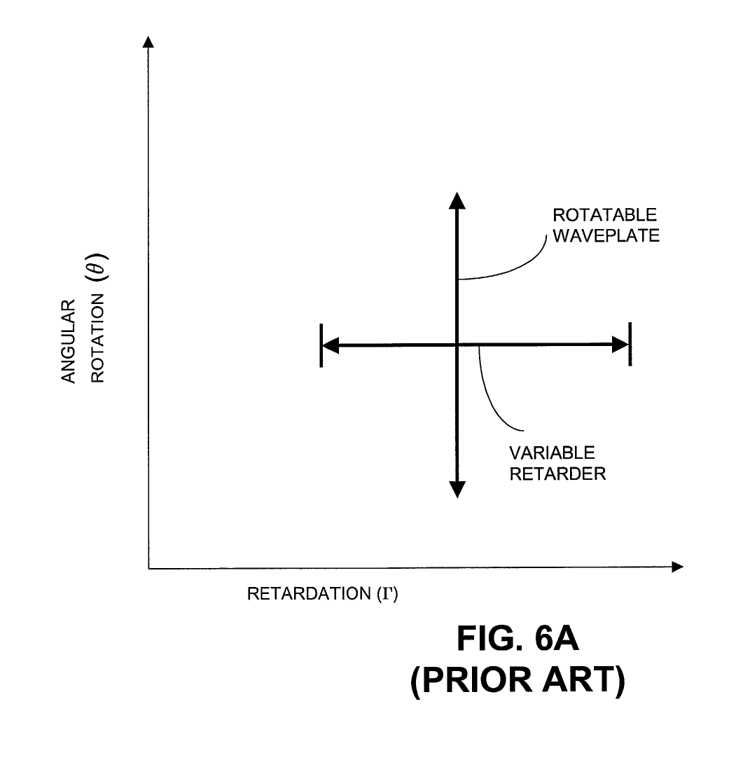

It will be appreciated that the hybrid control method of this invention can also be described in retardation-angle space. As mentioned above with reference to FIG. 6A, conventional operation of a rotatable waveplate or a variable retarder can be illustrated as motion along a vertical line or a horizontal line, respectively. Operation of a hybrid device, however, can be illustrated as motion along a generalized curve between any two reachable points in the retardation-angle space of FIG. 6A. That is, the motion need not be restricted to substantially vertical or substantially horizontal. Thus, this freedom allows a control section to more rapidly reach a desired or optimized retardation and angle state.

All of the hybrid methods according to this invention can be performed using a computer, which can be, for example, an application specific integrated circuit, a programmable microprocessor, or a general-purpose computer programmed to perform the method. Thus, a polarization transformer could include any programmed or programmable control unit. The program causes the transformation of the state of polarization of an electromagnetic wave using a hybrid polarization transformer, which includes at least one section capable of supplying a first retardation and a first angular rotation. The program causes the retardation and angular rotation to vary.

Thus, improved methods and apparatus for polarization transformation, tracking, and control are provided. One skilled in the art will appreciate that the present invention can be practiced by other than the described embodiments, which are presented for purposes of illustration and not of limitation. For example, polarization dependent loss controllers, optical polarization trackers, principle state compensators, and high precision polarization scramblers can be constructed according to this invention. The present invention is limited only by the claims that follow.

We claim:

1. A method for transforming the state of polarization of an electromagnetic wave using a hybrid polarization transformer comprising at least one section capable of supplying a first retardation and a first angular rotation, said method comprising:
varying said first retardation; and
varying said first angular rotation.

2. The method of claim 1 wherein said varying said first retardation and said first angular rotation are performed substantially simultaneously.

3. The method of claim 1 wherein said varying said first retardation and said first angular rotation are performed alternatingly.

4. The method of claim 3 wherein said varying said first retardation is performed while said first angular rotation is substantially fixed and wherein said varying said first angular rotation is performed while said first retardation is substantially fixed.

5. The method of claim 1 wherein said varying said first retardation is performed while said first angular rotation is substantially fixed and wherein said varying said first angular rotation is performed while said first retardation is substantially fixed.

6. The method of claim 1 wherein said varying said first angle rotation comprises:
measuring a first feedback value;
dithering said first angle rotation by an angular rotation dither step;
measuring a second feedback value;
calculating a new angular rotation based on a gradient calculation; and
setting said first angular rotation to said new angular rotation.

7. The method of claim 6 wherein said calculating said new angular rotation comprises calculating a gradient using an initial angular rotation, a difference between said first and second feedback values, and said angle rotation dither step.

8. The method of claim 6 wherein said varying said first retardation comprises:
measuring a first feedback value;
dithering said first retardation by a retardation dither step;
measuring a second feedback value;
calculating new retardation value based on a gradient calculation; and
setting said first retardation to said new retardation value.

9. The method of claim 8 wherein said calculating said new retardation comprises calculating a gradient using an initial retardation value, a difference between said first and second feedback values, and said retardation dither step.

10. The method of claim 9 wherein said calculating comprises limiting said new retardation value to a maximum retardation value.

11. The method of claim 1 wherein said varying said first retardation comprises:
measuring a first feedback value;
dithering said first retardation by a retardation dither step;
measuring a second feedback value;
calculating new retardation value based on a gradient calculation; and
setting said first retardation to said new retardation value.

12. The method of claim 11 wherein said calculating comprises limiting said new retardation value to a maximum retardation value.

13. The method of claim 1 wherein said varying said first angular rotation comprises, after measuring a first feedback value and initializing a SIGN parameter:
dithering said first angular rotation;
measuring a second feedback value;
determining impact of said dithering based on a calculated difference between said first and second feedback values;
setting said first angular rotation to a new angular rotation; and
setting said first feedback value equal to second feedback value.

14. The method of claim 13 further comprising calculating said new angular rotation based on said calculated difference.

15. The method of claim 1 wherein said varying said first retardation comprises, after measuring a first feedback value and initializing a SIGN parameter:
dithering said first retardation;
measuring a second feedback value;
determining impact of said dithering based on a calculated difference between said first and second feedback values;
setting said first retardation to a new retardation; and
setting said first feedback value equal to said second feedback value.

16. The method of claim 15 further comprising calculating said new retardation based on said calculated difference.

17. The method of claim 1 wherein said at least one section comprises at least a first section and a second section, wherein said second section has a second retardation and a second angular rotation, wherein said varying said first retardation and said first angular rotation is performed by said first section, and wherein said method further comprises:
varying a control parameter selected from a group consisting of said second retardation and said second angular rotation while holding the other control parameter in the group fixed.

18. The method of claim 1 wherein said at least one section comprises at least a first section and a second section, wherein said second section has a second retardation and a second angular rotation, and wherein said varying said first retardation and said first angular rotation is performed by said first section, said method further comprising:
varying said second retardation; and
varying said second angular rotation.

19. The method of claim 18 wherein said varying said first and second retardations and said first and second angular rotations are performed substantially simultaneously.

20. The method of claim 18 wherein said varying said second retardation and said second angular rotation are performed alternatingly.

21. The method of claim 18 wherein said varying said first retardation and said first angular rotation and said varying said second retardation and said second angular rotation are performed substantially simultaneously.

22. The method of claim 18 wherein at least one of said varying said first retardation and varying said first angular rotation is performed alternatingly with at least one of said varying said second retardation and said varying said second angular rotation.

23. The method of claim 1 wherein:
said varying said first retardation comprises dithering said first retardation at a first frequency; and
said varying said first angular rotation comprises dithering said first angular rotation at a second frequency.

24. The method of claim 23 wherein said at least one section comprises at least a first section and a second section, wherein said second section has a second retardation and a second angular rotation, and wherein said varying said first retardation and said first angular rotation is performed by said first section, said method further comprising:
varying said second retardation, which comprises dithering said second retardation at a third frequency; and
varying said second angular rotation, which comprises dithering said second angular rotation at a fourth frequency.

25. A memory containing a computer program of instructions for transforming the state of polarization of an electromagnetic wave using a hybrid polarization transformer comprising at least one section capable of supplying a first retardation and a first angular rotation, said program comprising:
varying said first retardation; and
varying said first angular rotation.

26. The memory of claim 25 wherein said varying said first retardation and said first angular rotation are performed substantially simultaneously.

27. The memory of claim 25 wherein said varying said first retardation and said first angular rotation are performed alternatingly.

28. The memory of claim 25 wherein said varying said first retardation is performed while said first angular rotation is substantially fixed and wherein said varying said first angular rotation is performed while said first retardation is substantially fixed.

29. The memory of claim 25 wherein said varying said first angle rotation comprises:
measuring a first feedback value;
dithering said first angle rotation by an angular rotation dither step;
measuring a second feedback value;
calculating a new angular rotation based on a gradient calculation; and
setting said first angular rotation to said new angular rotation.

30. The memory of claim 25 wherein said varying said first retardation comprises:
measuring a first feedback value;
dithering said first retardation by a retardation dither step;
measuring a second feedback value;
calculating new retardation value based on a gradient calculation; and
setting said first retardation to said new retardation value.

31. The memory of claim 25 wherein said varying said first angular rotation comprises, after measuring a first feedback value and initializing a SIGN parameter:
dithering said first angular rotation;
measuring a second feedback value;
determining impact of said dithering based on a calculated difference between said first and second feedback values;
setting said first angular rotation to a new angular rotation; and
setting said first feedback value equal to second feedback value.

32. The memory of claim 25 wherein said varying said first retardation comprises, after measuring a first feedback value and initializing a SIGN parameter:
dithering said first retardation;
measuring a second feedback value;
determining impact of said dithering based on a calculated difference between said first and second feedback values;
setting said first retardation to a new retardation; and
setting said first feedback value equal to said second feedback value.

33. The memory of claim 25 wherein said at least one section comprises at least a first section and a second section, wherein said second section has a second retardation and a second angular rotation, and wherein said varying said first retardation and said first angular rotation is performed by said first section, said method further comprising:
varying said second retardation; and
varying said second angular rotation.

34. The memory of claim 33 wherein said varying said first and second retardations and said first and second angular rotations are performed substantially simultaneously.

35. The memory of claim 33 wherein said varying said second retardation and said second angular rotation are performed alternatingly.

36. The memory of claim 33 wherein said varying said first retardation and said first angular rotation and said varying said second retardation and said second angular rotation are performed substantially simultaneously.

37. The memory of claim 25 wherein:
said varying said first retardation comprises dithering said first retardation at a first frequency; and
said varying said first angular rotation comprises dithering said first angular rotation at a second frequency.

38. The memory of claim 37 wherein said at least one section comprises at least a first section and a second section, wherein said second section has a second retardation and a second angular rotation, and wherein said varying said first retardation and said first angular rotation is performed by said first section, said method further comprising:
varying said second retardation, which comprises dithering said second retardation at a third frequency; and
varying said second angular rotation, which comprises dithering said second angular rotation at a fourth frequency.

39. A hybrid polarization transformer comprising:
at least one section capable of supplying a first variable retardation and a first variable angular rotation; and
a controller programmed to vary said first variable retardation and said first variable angular rotation.

40. The transformer of claim 39 wherein said controller varies said first retardation and said first angular rotation substantially simultaneously.

41. The transformer of claim 39 wherein said controller varies said first retardation and said first angular rotation alternatingly.

42. The transformer of claim 39 wherein said controller varies said first retardation while said first angular rotation is substantially fixed and wherein said controller varies said first angular rotation while said first retardation is substantially fixed.

43. The transformer of claim 39 wherein said controller varies said first angle rotation by measuring a first feedback value, dithering said first angle rotation by an angular rotation dither step, measuring a second feedback value, calculating a new angular rotation based on a gradient calculation, and setting said first angular rotation to said new angular rotation.

44. The transformer of claim 43 wherein said controller varies said first retardation by measuring a first feedback value, dithering said first retardation by a retardation dither step, measuring a second feedback value, calculating new retardation value based on a gradient calculation, and setting said first retardation to said new retardation value.

45. The transformer of claim 39 wherein said controller varies said first angular rotation, after measuring a first feedback value and initializing a SIGN parameter, by dithering said first angular rotation, measuring a second feedback value, determining impact of said dithering based on a calculated difference between said first and second feedback values, setting said first angular rotation to a new angular rotation, and setting said first feedback value equal to second feedback value.

46. The transformer of claim 45 wherein said controller varies said first retardation, after measuring a first feedback value and initializing a SIGN parameter, by dithering said first retardation, measuring a second feedback value, determining impact of said dithering based on a calculated difference between said first and second feedback values, setting said first retardation to a new retardation, and setting said first feedback value equal to said second feedback value.

47. The transformer of claim 39 wherein said at least one section comprises at least a first section and a second section, wherein said second section has a second retardation and a second angular rotation, and wherein said varying said first retardation and said first angular rotation is performed by said first section, said controller is also programmed to:
vary said second retardation; and
vary said second angular rotation.

48. The transformer of claim 39 wherein said controller is programmed to:
dither said first retardation at a first frequency; and
dither said first angular rotation at a second frequency.

49. The transformer of claim 39 wherein said at least one section comprises a plurality of sections, each of said sections having a minimum retardation and a maximum retardation, and wherein a summation of said maximum retardations at least equals to a full wave of retardation.

50. The transformer of claim 39 wherein a summation of said minimum retardations at least equals to a full wave of retardation.

51. A polarization mode dispersion compensator comprising:
a hybrid polarization transformer having an input for receiving an optical beam and an output for providing a polarization transformed beam, said transformer comprising at least one section capable of supplying a first variable retardation and a first variable angular rotation;
a PMD generator in optical alignment with said transformer;
an optical distortion analyzer for receiving a portion of the transformed beam and providing signal that is indicative of a quality of the transformed beam; and
a transformer controller that controls the transformer based on the quality, wherein said generator is programmed to vary said first variable retardation and said first variable angular rotation.

52. The compensator of claim 51 wherein said controller varies said first retardation and said first angular rotation substantially simultaneously.

53. The compensator of claim 51 wherein said controller varies said first retardation and said first angular rotation alternatingly.

54. The compensator of claim 51 wherein said controller varies said first retardation while said first angular rotation is substantially fixed and wherein said controller varies said first angular rotation while said first retardation is substantially fixed.

55. The compensator of claim 51 wherein said controller varies said first angle rotation by measuring a first feedback value, dithering said first angle rotation by an angular rotation dither step, measuring a second feedback value, calculating a new angular rotation based on a gradient calculation, and setting said first angular rotation to said new angular rotation.

56. The compensator of claim 55 wherein said controller varies said first retardation by measuring a first feedback value, dithering said first retardation by a retardation dither step, measuring a second feedback value, calculating new retardation value based on a gradient calculation, and setting said first retardation to said new retardation value.

57. The compensator of claim 51 wherein said controller varies said first angular rotation, after measuring a first feedback value and initializing a SIGN parameter, by dithering said first angular rotation, measuring a second feedback value, determining impact of said dithering based on a calculated difference between said first and second feedback values, setting said first angular rotation to a new angular rotation, and setting said first feedback value equal to second feedback value.

58. The compensator of claim 57 wherein said controller varies said first retardation, after measuring a first feedback value and initializing a SIGN parameter, by dithering said first retardation, measuring a second feedback value, determining impact of said dithering based on a calculated difference between said first and second feedback values, setting said first retardation to a new retardation, and setting said first feedback value equal to said second feedback value.

59. The compensator of claim 51 wherein said at least one section comprises at least a first section and a second section, wherein said second section has a second retardation and a second angular rotation, and wherein said varying said first retardation and said first angular rotation is performed by said first section, said controller is also programmed to:
vary said second retardation; and
vary said second angular rotation.

60. The compensator of claim 51 wherein said controller is programmed to:
dither said first retardation at a first frequency; and
dither said first angular rotation at a second frequency.

61. A dynamic optical distortion compensator comprising:
initial polarization transformer for transforming a polarization state of an optical signal;
PMD generator in optical alignment with said transformer for receiving said transformed optical signal and generating an amount of compensating distortion;
a feedback sensor for receiving at least a portion of said optical signal after being received by said generator and generating an electrical signal;
demultiplexer coupled to said sensor for receiving said electrical signal and splitting it into a plurality of separate signals; and
optical distortion analyzer and controller for receiving said separate signals and generating control signals for controlling at least said polarization transformer.

62. The compensator of claim 61 wherein said PMD generator comprises an internal polarization transformer that is coupled to said controller.

63. The compensator of claim 61 wherein said transformer comprises at least one control section, and wherein said controller is programmed to operate said control section as a hybrid section.

64. The compensator of claim 63 wherein said controller is programmed to vary a retardation and an angular rotation of said section.

65. The compensator of claim 64 wherein said controller is programmed to vary said retardation and said angular rotation substantially simultaneously.

66. The compensator of claim 64 wherein said controller is programmed to vary said retardation and said angular rotation alternatingly.

67. The compensator of claim 64 wherein said controller is programmed to alternatingly (a) vary said retardation while said angular rotation is substantially fixed and (b) vary said angular rotation while said retardation is substantially fixed.

68. The compensator of claim 64 wherein said controller is programmed to vary said retardation and said angular rotation periodically.
